(19) United States
(12) Patent Application Publication
(10) Pub. No.: US 2009/0299810 A1
(43) Pub. Date: Dec. 3, 2009

(54) COMBINING TASKS AND EVENTS

(76) Inventors: Joseph M. Jardine, Seattle, WA (US); James A. Raynolds, Ladera Ranch, CA (US)

Correspondence Address: PERKINS COIE LLP;PATENT-SEA, P.O. BOX 1247, SEATTLE, WA, 98111-1247, US

(21) Appl. No.: 12/464,069

(22) Filed: May 11, 2009

Related U.S. Application Data
(60) Provisional application No. 61/052,137, filed on May 9, 2008.

(51) Int. Cl. G06Q 10/00

(52) U.S. Cl. 705/9

(57) ABSTRACT

A software application (“smarttime system”) for combining tasks and events is described. The software application provides a user interface for viewing and sorting tasks dynamically, taking into consideration multiple possible prioritization factors in one view; In various embodiments, the smarttime system integrates tasks and events from conventional databases into a common calendar (“smarttime calendar”) to provide a user interface for easily managing tasks and events.

### CROSS-REFERENCE TO RELATED APPLICATION(S)

This patent application claims the benefit of U.S. Provisional Patent Application No. 61/052,137, entitled “Combining Tasks and Events,” filed on May 9, 2008, and which is incorporated herein in its entirety by reference.

### BACKGROUND

In the following, the words “time” and “date” are used interchangeably to mean “date,” “time,” or “date and time” based on the context of use. One skilled in the art will recognize whether the used word means time, date, or date and time based on the context of the use of that word.

A task is an item that has no fixed start or finish time, but which may have a specific due date. A task may have an estimated duration. Example of tasks are items in a user's “to do” list.

An event is an item, usually appearing in a calendar, which has a fixed start time, and a fixed end time. An event also has a duration. Examples of events are appointments and meetings.

Conventional calendaring software applications and task management software applications can display both tasks and events in one application, but do not truly integrate the two. These applications may show tasks alongside a calendar containing events. Some applications enable a user to copy or move a task onto a calendar, thus converting that task into an event. However, tasks and events remain segregated so that once a task is converted into an event, it is no longer stored or handled as a task item. Likewise, these conventional applications may enable events to be shown in a list similar to tasks. However, such events are not integrated or handled with task items. Some applications can link separate database items such as tasks, events, and phone book contact lists, so that users can create a list of linked items from any one category. However, these links are static and are neither interactive nor visually integrated into graphic user interface (GUI).

In a conventional task database, it is difficult to view or manipulate relationships between tasks. For example, if tasks are sorted by “due date,” it can be difficult to understand other factors that might be involved in sorting or prioritizing tasks, such as “length of time needed to complete,” “priority,” “task type,” “relevance to other tasks,” etc.

Most task lists are static lists. Even after users prioritize their tasks in the list of tasks, the users still may need to determine how to manage those tasks into the day, including completing the tasks despite having other events in the calendar, such as meetings and appointments.

### BRIEF DESCRIPTION OF THE DRAWINGS

FIG. 1 is a block diagram illustrating an environment for a smarttime system in some embodiments.

FIG. 2 is a flow diagram illustrating an entry point into the smarttime system in some embodiments.

FIG. 3 is a flow diagram illustrating refresh logic invoked by the smarttime system in some embodiments.

FIG. 4 is a flow diagram illustrating an entry point into the smarttime system in some embodiments.

FIG. 5 is a flow diagram illustrating logic invoked by the smarttime system in some embodiments when a user adds a new event to a smarttime calendar.

FIG. 6 is a flow diagram illustrating logic invoked by the smarttime system in some embodiments when a user adds a new task to a smarttime calendar.

FIG. 7 is a flow diagram illustrating logic invoked by the smarttime system in some embodiments when a user updates an event in a smarttime calendar.

FIG. 8 is a flow diagram illustrating logic invoked by the smarttime system in some embodiments when a user updates a task in a smarttime calendar.

FIG. 9 is a flow diagram illustrating logic invoked by the smarttime system in some embodiments when a user deletes an event in a smarttime calendar.

FIG. 10 is a flow diagram illustrating logic invoked by the smarttime system in some embodiments when a user deletes a task in a smarttime calendar.

FIG. 11 is a flow diagram illustrating logic invoked by the smarttime system in some embodiments when a user defers an event in a smarttime calendar.

FIG. 12 is a flow diagram illustrating logic invoked by the smarttime system in some embodiments when a user defers a task in a smarttime calendar.

FIG. 13 is a flow diagram illustrating logic invoked by the smarttime system in some embodiments when a user marks an event as completed in a smarttime calendar.

FIG. 14 is a flow diagram illustrating logic invoked by the smarttime system in some embodiments when a user duplicates an event in a smarttime calendar.

FIG. 15 is a flow diagram illustrating logic invoked by the smarttime system in some embodiments when a user duplicates a task in a smarttime calendar.

FIG. 16 is a flow diagram illustrating logic invoked by the smarttime system in some embodiments to automatically schedule tasks and/or events.

FIG. 17 is a flow diagram illustrating logic invoked by the smarttime system in some embodiments to identify a timeslot for a task.

FIGS. 18-21 are flow diagrams illustrating logic invoked by the smarttime system in various embodiments to synchronize a smarttime calendar.

FIGS. 22-32F are user interface diagrams illustrating aspects of a user interface provided by the smarttime system in various embodiments.

### DETAILED DESCRIPTION

A software application (“smarttime system”) for combining tasks and events is described. In various embodiments, the software application (1) provides a user interface for viewing and sorting tasks dynamically, taking into consideration multiple possible prioritization factors in one view; (2) completely integrating tasks and events into a unique view; (3) by automatically organizing the tasks into that view, together with events, thus completely organizing a person's work day and home life; and (4) by creating a dynamic line that automatically marks each ‘day’ in the View based upon time allocated for both events and tasks. Once tasks and events are organized into the shared view, they can be re-ordered by (5) moving them with the touch of a finger or other pointing device; or (6) by dragging and dropping them onto one of several action icons. (7) A task or event can also be split into two or more tasks/events intuitively, using finger or pointing device gestures. (8) The software also enables users to create lists that can be attached to recurring tasks and re-used, e.g., shopping lists, homework lists, and business process lists.

In various embodiments, the smarttime system integrates tasks and events from conventional databases into a common calendar (“smarttime calendar”). When tasks or events are added, removed, or modified in the smarttime calendar, the smarttime system may reassign other tasks to available time segments based on various priorities. As an example, the smarttime system's logic may employ the following priority order: (1) events; (2) tasks with a fixed start and end time (e.g., “horizon” tasks that must be done after a specified time but before another specified time); (3) tasks with a fixed end time (e.g., due date); (4) tasks with a fixed start time; and (5) open-ended tasks with no fixed start or end time. When a task or event is added, removed, or modified in the smarttime calendar, the smarttime system may assign a task having a fixed end time or fixed start time to an available time segment before another task having no fixed start or end time. In various embodiments, the smarttime system may employ other priority ordering.

Several embodiments of the facility are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the importance system. In addition, the data structures and message structures may be stored or transmitted via a data transmission medium, such as a signal on a communications link. Various communications links may be used, such as the Internet, a local area network, a wide area network, or a point-to-point dial-up connection.

A horizon task is a task that has a user-specified start date. The smarttime system can schedule such tasks after the specified start date. Tasks may have both horizons and deadlines (e.g., a window during which the task should be completed).

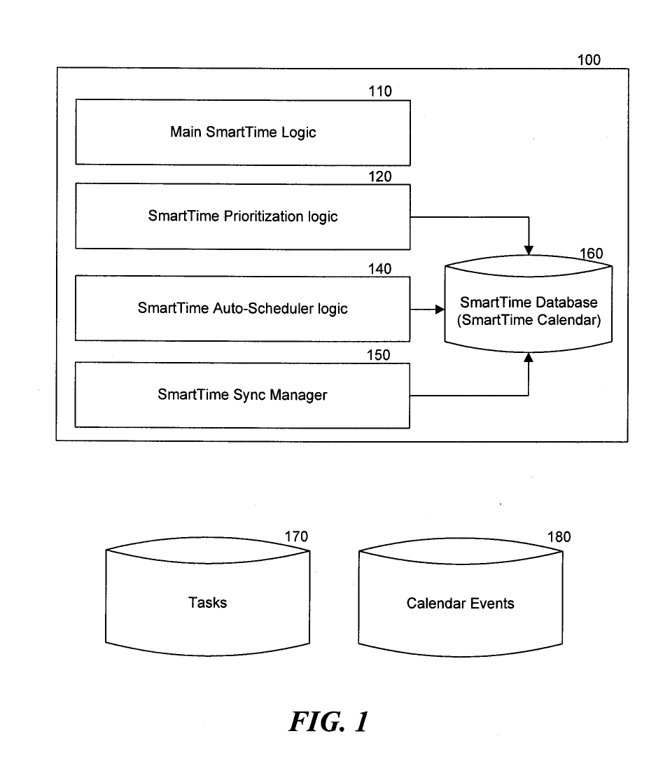

Turning now to the figures, FIG. 1 is a block diagram illustrating an environment for a smarttime system in some embodiments. The environment 100 can include one or more components, some or all of which may be implemented in software or hardware. The one or more components may operate in association with a handheld computing device, such as a mobile telephone. In some embodiments, the smarttime system 100 operates in an APPLE IPHONE, MICROSOFT smart phone, etc. The components can include a main smarttime logic 110, a smarttime prior translation logic 120, a smarttime auto scheduler logic 140, and a smarttime sync manager 150. The main smarttime logic 110 may provide a user interface and other logic to enable the smarttime environment to provide services to a user. It may operate with the smarttime prioritization logic 120 to prioritize tasks and events stored in a smarttime calendar. The smarttime calendar may be stored in a smarttime database 160. The smarttime auto scheduler logic 140 may automatically schedule tasks within a given smarttime calendar, e.g., when the smarttime calendar comprises one or more previously scheduled events. The smarttime sync manager 150 can synchronize the smarttime calendar with tasks and events stored outside the smarttime system 100, e.g., in a tasks database 170, calendar events database 180, or other components or databases (not illustrated). As an example, the tasks 170 and the events 180 may be stored in conventional databases, e.g., MICROSOFT OUTLOOK, GOOGLE Calendar, etc.

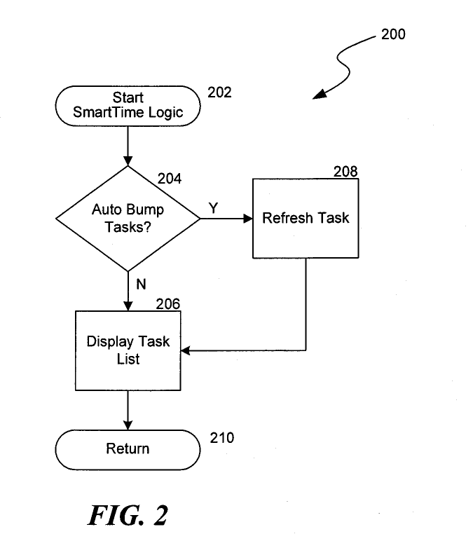

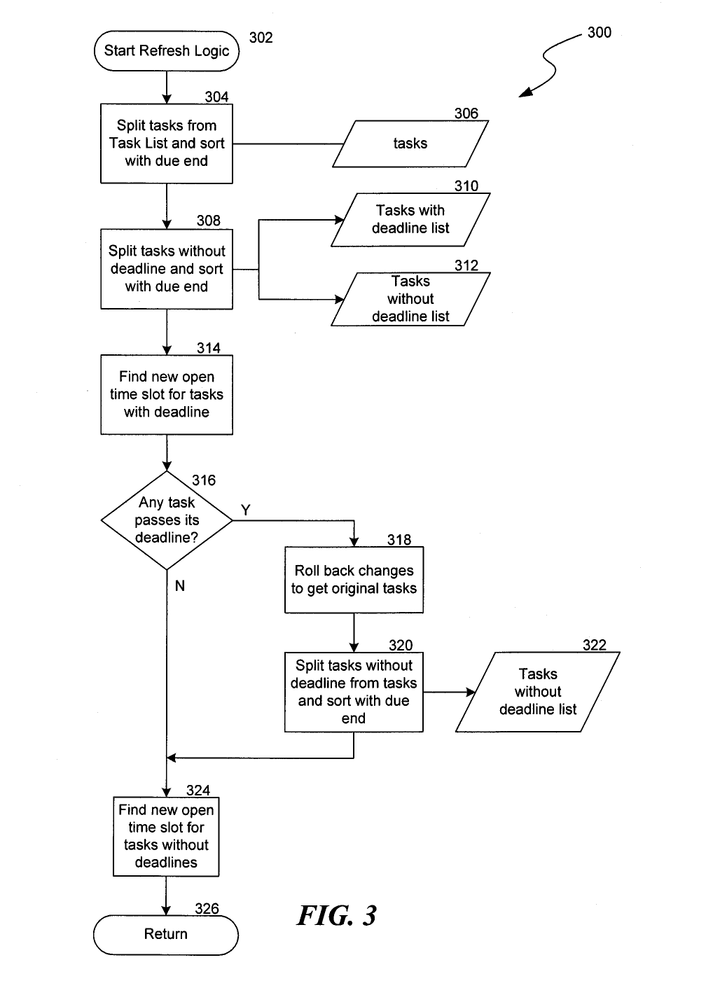

FIG. 2 is a flow diagram illustrating an entry point into the smarttime system in some embodiments. The illustrated routine 200 may be invoked when the user starts a smarttime application. The routine 200 begins at block 202. At decision block 204, the routine determines whether a setting indicates to automatically bump tasks. The setting to automatically bump tasks indicates to the smarttime system that when the smartphone system starts, it is to automatically move tasks that have not been indicated as completed forward in time so as to reschedule them for completion. By turning the setting off, the user may be able to speed up the smarttime system because computations to move tasks may not need to be performed. If the setting is to automatically bump tasks, the routine continues at block 208. Otherwise, the routine continues at block 206. At block 208, the routine refreshes the task list. As an example, the routine invokes a subroutine to be fresh a task list. The subroutine is illustrated below in relation to capital FIG. 3. After completing the logic of block 208, the routine continues at block 206, where it displays a task list. The task list may be displayed in relation to events from a smarttime calendar. The routine then returns at block 210.

Those skilled in the art will appreciate that the logic illustrated in FIG. 2 and described above, and in each of the flow diagrams discussed below, may be altered in a variety of ways. For example, the order of the logic may be rearranged, substeps may be performed in parallel, illustrated logic may be omitted, other logic may be included, etc.

FIG. 3 is a flow diagram illustrating refresh logic invoked by the smarttime system in some embodiments. Refresh logic 300 may be invoked to reschedule tasks, such as when (1) starting the smarttime application; (2) the user defers a task to another date, (3) the user sets a starts time or end time for a task, (4) the user deletes a task or marks it done, etc. The routine implementing the refresh logic 300 begins at block 302. At block 304, the routine retrieves tasks from a system task list 306 and sorts them based on when the tasks are indicated to have an end date. At block 308, the routine splits tasks based on whether they have end dates (e.g., deadlines) and sorts them based on the end dates. The routine then stores the tasks with the end dates in storage 310 and stores the tasks without an end date in storage 312. The logic of block 308 may operate on tasks stored in the storage 306 by the logic of block 304 or on a separate task list. At block 314, the routine locates an open time slot for tasks having a deadline, e.g., tasks stored in storage 310. At decision block 316, the routine determines whether any task passes its deadline. A task passes its deadline when it is scheduled for a time after its indicated end date. If any task passes its deadline, the routine continues at block 318. Otherwise, the routine continues at block 324. At block 318, the routine rolls back changes to return tasks to their previously scheduled dates and may display an error message. At block 320, the routine splits tasks that do not have a deadline from all the tasks and sorts the tasks by their due date. The routine then stores the tasks without a deadline in storage 322. At block 324, the routine finds a timeslot for tasks without deadlines. Once a timeslot is found, the routine may indicate the timeslot for the task in the smarttime calendar. The routine then returns at block 326.

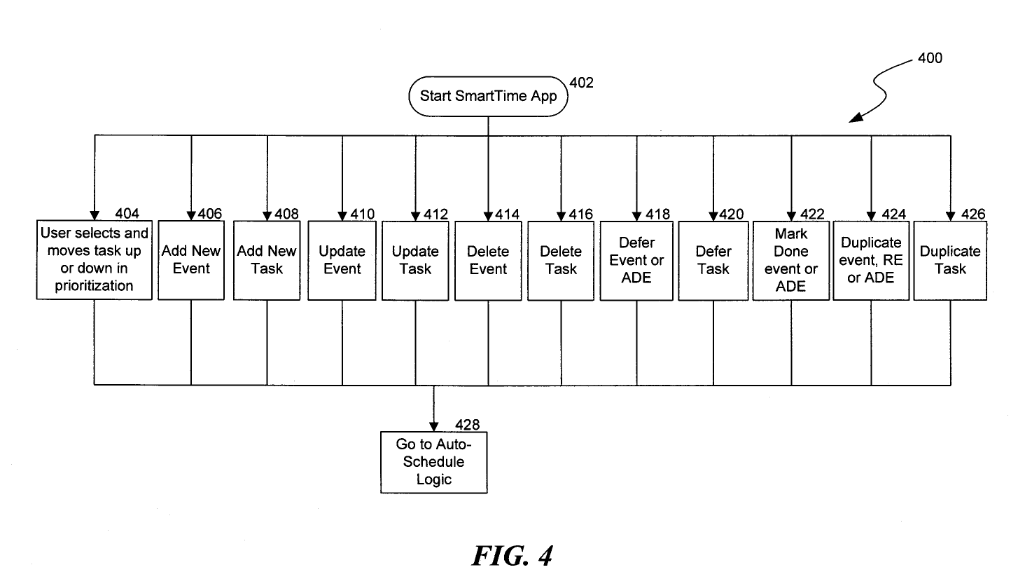

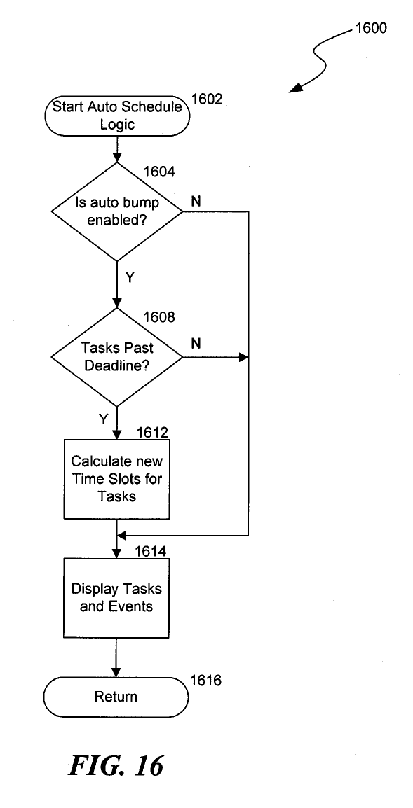

FIG. 4 is a flow diagram illustrating an entry point into the smarttime system in some embodiments. After the user starts the smarttime application (block 402), the smarttime application may invoke one or more routines for 400 based on actions the user may take or other stimuli. As examples, a user may select a task and changes prior translation 404, add a new event 406, add a new task 408, update an event (e.g. to change its start time, and time, or duration) 410, update a task 412, delete an event 414, delete a task 416, defer an event or an all-day event (ADE) 418, different a task 420, mark an event or an all-day event done 422, duplicate an event (e.g., repeating event (RE), ADE, etc.) 424, duplicate a task 426, etc. The routine may invoke auto-rescheduling logic 428 when the user provides these stimuli. The auto rescheduling logic is described in further detail below in relation FIG. 16.

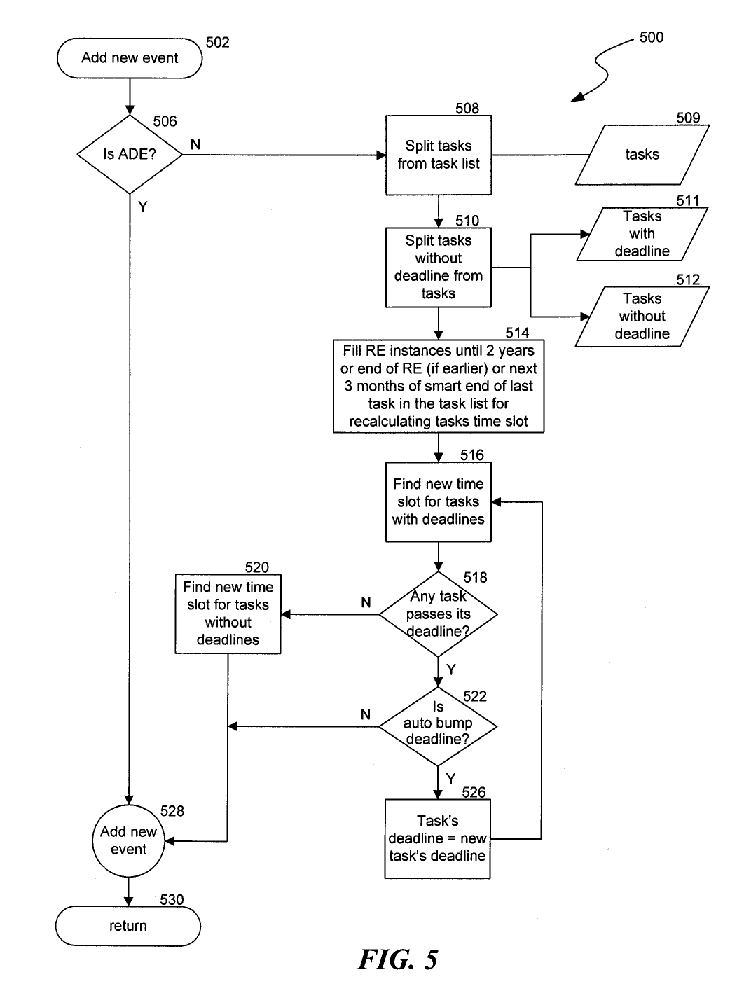

FIG. 5 is a flow diagram illustrating logic invoked by the smarttime system in some embodiments when a user adds a new event to a smarttime calendar. The smarttime system may invoke the routine 500 when a new event is added. The routine begins at block 502. At decision block 506, the routine determines whether the event is an all-day event. If the event is an all-day event, the routine continues at block 528. Otherwise, the routine continues at block 508. At block 508, the routine splits tasks from the task list (e.g., a system task list) and stores the tasks in storage 509. At block 510, the routine splits tasks not having a deadline (e.g., end date) from the task list. The routine stores tasks having a deadline in storage 511 and tasks not having a deadline in storage 512. At block 514, the routine adds to the smarttime calendar instances of repeating events as follows: (1) for the next two years; (2) end of the repeating event period if the ending is specified earlier than two years later; or (3) next three months when recomputing a timeslot for a task. At block 516, the routine finds new timeslots for tasks having deadlines. When finding timeslots, the smarttime system may identify periods of time during which no event has been scheduled for at least some specified duration. As an example, if the user has a meeting at 9 AM that is scheduled to last for two hours and another meeting at 3 PM that is scheduled to last for one hour, the smarttime system may schedule tasks between 11 AM and 3 PM. The smarttime system may also schedule tasks between 4 PM and a specified end of the day. At decision block 518, the routine determines whether any automatically scheduled task passes its deadline. If that is the case, the routine continues at decision block 522. Otherwise, the routine continues at block 520. At block 520, the routine identifies new timeslots for tasks not having deadlines and then adds the new event at block 528. At decision block 522, the routine determines whether a setting has been set to automatically bump deadlines. The setting was described above. If the setting has been set, the routine continues at block 526. Otherwise, the routine adds the new event at block 528. At block 526, the routine sets the task's deadline to a new deadline. The routine then continues at block 516. The routine returns at block 530.

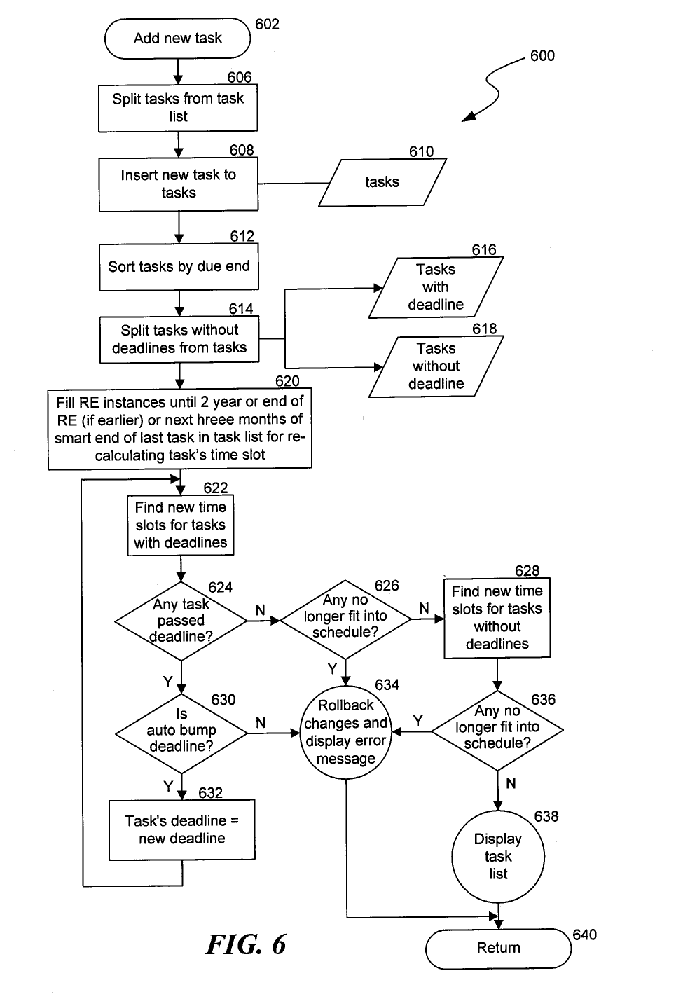

FIG. 6 is a flow diagram illustrating logic invoked by the smarttime system in some embodiments when a user adds a new task to a smarttime calendar. The smarttime system may invoke the routine 600 when a new task is added. The routine begins at block 602. At block 606, the routine splits tasks from the task list (e.g., a system task list), stores them in tasks storage 610 and inserts the new task to the tasks stored in storage 610. At block 612, the routine sorts the stored tasks by their end date (e.g., deadline). At block 614, the routine splits tasks not having a deadline (e.g., end date) from the task list. The routine stores tasks having a deadline in storage 616 and tasks not having a deadline in storage 618. At block 620, the routine editors into the smarttime calendar instances of repeating events as follows: (1) for the next two years; (2) end of the repeating event period if the ending is specified earlier than two years later; or (3) next three months when recomputing a timeslot for a task. At block 622, the routine finds new timeslots for tasks having deadlines. When finding timeslots, the smarttime system may identify periods of time during which no event has been scheduled for at least some specified duration. At decision block 624, the routine determines whether any automatically scheduled task passes its deadline. If that is the case, the routine continues at decision block 630. Otherwise, the routine continues at decision block 626. At decision block 626, the routine determines whether any of the tasks no longer fits into the schedule. If that is the case, the routine continues at block 634. Otherwise, the routine continues at block 628. At block 628, the routine finds new timeslots for tasks not having deadlines and then continues at decision block 636. At decision block 636, the routine determines whether any tasks (e.g., tasks not having deadlines) no longer fits into the schedule. If that is the case, the routine continues at block 634. Otherwise, the routine continues at block 638. At decision block 630, the routine determines whether a setting has been set to automatically bump deadlines. The setting was described above. If the setting has been set, the routine continues at block 632. Otherwise, the routine continues at block 634. At block 632, the routine set's the task's deadline to a new deadline and then continues at block 622. At block 634, the routine rolls back the changes made by the routine and may display an error message before returning at block 640. At block 638, the routine displays the task list (e.g., in association with the smarttime calendar) and then returns at block 640.

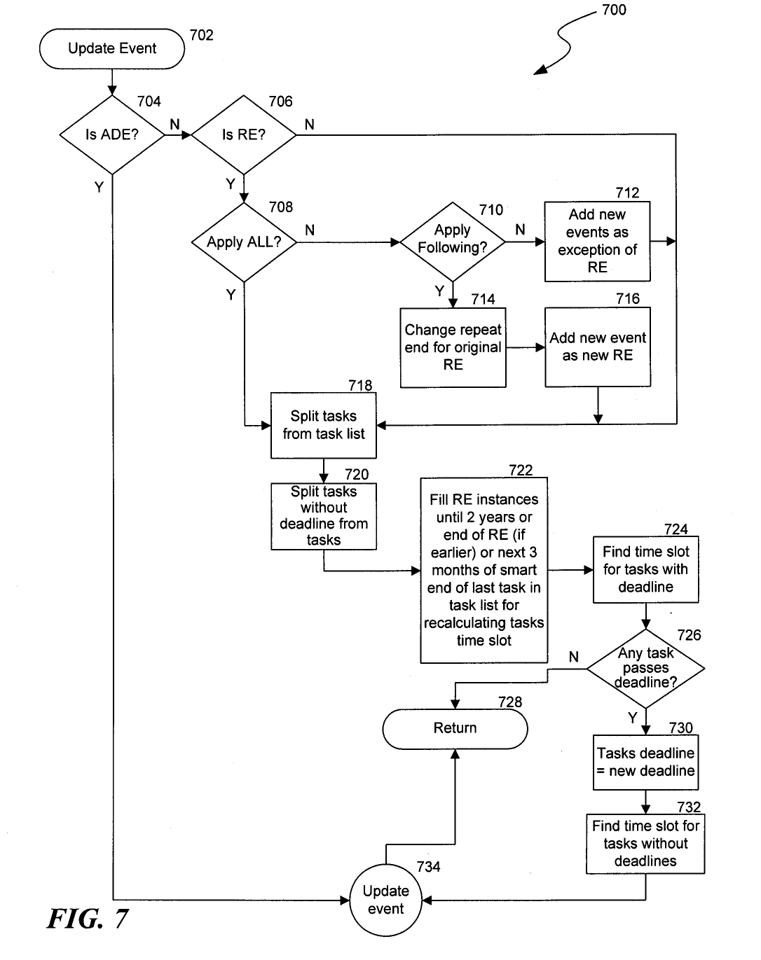

FIG. 7 is a flow diagram illustrating logic invoked by the smarttime system in some embodiments when a user updates an event in a smarttime calendar. The smarttime system may invoke the routine 700 when an event is updated to reschedule tasks automatically. For example, updating an event may cause the schedule to have an opening during which a task can be completed. Alternatively, the updated event may cause a timeslot to no longer be available t 0 complete a task. The routine begins at block 702. At decision block 704, the routine determines whether the event is an all-day event. If the event is an all-day event, the routine continues at block 734. Otherwise, the routine continues at decision block 706. At decision block 706, the routine determines whether the event is a recurring event (RE). If the event is an RE, the routine continues at decision block 708. Otherwise, the routine continues at block 718. At decision block 708, the routine determines whether the update applies to all recurring events. If so, the routine continues at block 718. Otherwise, the routine continues at decision block 710. At decision block 710, the routine determines whether the update applies to all following recurring events. If so, the routine continues at block 714. Otherwise, the routine continues at block 712. At block 712, the routine adds new events as exceptions to the previously scheduled recurring events and continues at block 718. At block 714, the routine changes the end dates for the recurring events and adds the new event as a new recurring event. The routine then continues at block 718. At block 718, the routine splits tasks from the task list (e.g., a system task list) and stores the tasks in a storage. At block 720, the routine splits tasks not having a deadline (e.g., end date) from the task list. At block 722, the routine adds to the smarttime calendar instances of repeating events as follows: (1) for the next two years; (2) end of the repeating event period if the ending is specified earlier than two years later; or (3) next three months when recomputing a timeslot for a task. At block 724, the routine finds new timeslots for tasks having deadlines. When finding timeslots, the smarttime system may identify periods of time during which no event has been scheduled for at least some specified duration. At decision block 726, the routine determines whether any automatically scheduled task passes its deadline. If that is the case, the routine continues at decision block 730. Otherwise, the routine returns at block 728. At block 730, the routine sets the task's deadline to a new deadline (e.g., based on schedule openings). At block 732, the routine finds timeslots for tasks not having a deadline. At block 734, the routine updates the event and returns.

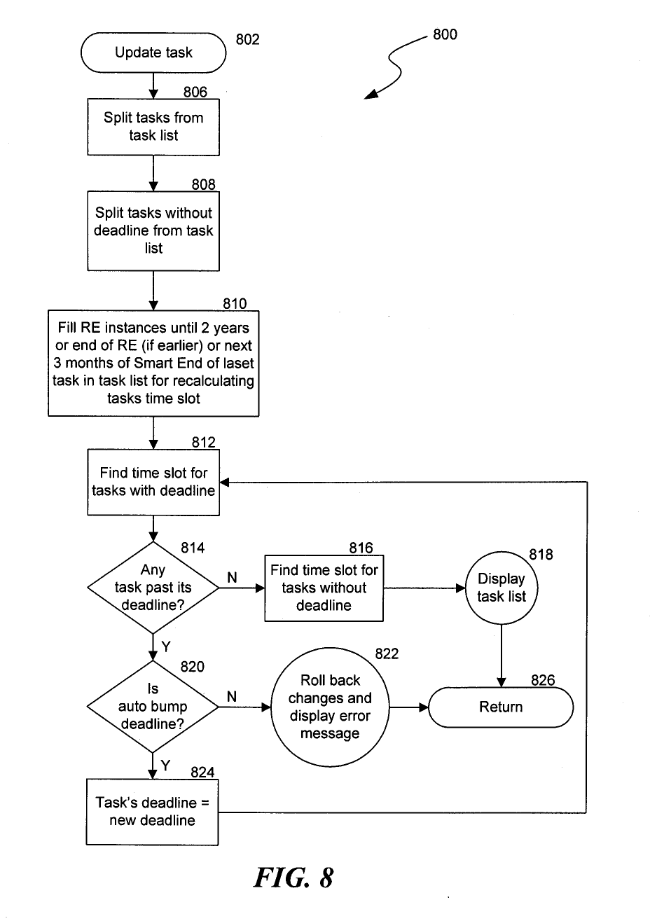

FIG. 8 is a flow diagram illustrating logic invoked by the smarttime system in some embodiments when a user updates a task in a smarttime calendar. The smarttime system may invoke the routine 800 when a task is updated to reschedule tasks automatically. For example, updating a task may need other tasks to be rescheduled. The routine begins at block 802. At block 806, the routine splits tasks from the task list (e.g., a system task list), stores them in a storage. At block 808, the routine splits tasks not having a deadline (e.g., end date) from the task list. At block 810, the routine into the smarttime calendar instances of repeating events as follows: (1) for the next two years; (2) end of the repeating event period if the ending is specified earlier than two years later; or (3) next three months when recomputing a timeslot for a task. At block 812, the routine finds new timeslots for tasks having deadlines. When finding timeslots, the smarttime system may identify periods of time during which no event has been scheduled for at least some specified duration. At decision block 814, the routine determines whether any automatically scheduled task passes its deadline. If that is the case, the routine continues at decision block 820. Otherwise, the routine continues at block 816. At block 816, the routine identifies new timeslots for tasks not having deadlines and then continues at block 818. At block 818, the routine displays the task list (e.g., in association with a smarttime calendar) and returns at block 826. At decision block 830, the routine determines whether a setting has been set to automatically bump deadlines. The setting was described above. If the setting has been set, the routine continues at block 824. Otherwise, the routine continues at block 822. At block 822, the routine rolls back the changes made by the routine and may display an error message before returning at block 826. At block 824, the routine sets the task's deadline to a new deadline (e.g., by finding an appropriate timeslot) and then continues at block 812. One skilled in the art will recognize that once the task is successfully updated and no tasks pass their deadlines and all tasks could be assigned time slots successfully, the routine can return without displaying an error message.

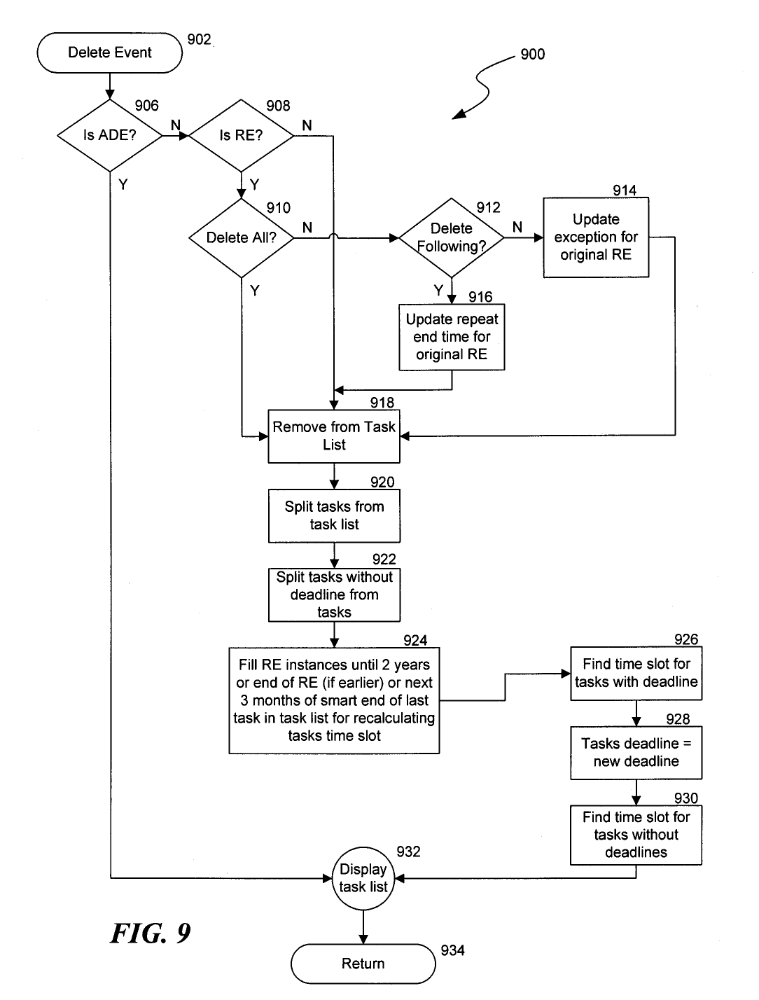

FIG. 9 is a flow diagram illustrating logic invoked by the smarttime system in some embodiments when a user deletes an event in a smarttime calendar. The smarttime system may invoke the routine 900 when an event is deleted. The routine begins at block 902. At decision block 906, the routine determines whether the event is an all-day event. If the event is an all-day event, the routine continues at block 932. Otherwise, the routine continues at decision block 908. At decision block 908, the routine determines whether the event is a recurring event (RE). If the event is an RE, the routine continues at decision block 910. Otherwise, the routine continues at block 918. At decision block 910, the routine determines whether all recurring events should be deleted (e.g., because the user so requests). If so, the routine continues at block 918. Otherwise, the routine continues at decision block 912. At decision block 912, the routine determines whether to delete following recurring events. If so, the routine continues at block 916. Otherwise, the routine continues at block 914. At block 914, the routine updates exceptions for the original repeating event (e.g., to remove only some repeating events) and continues at block 918. At block 916, the routine changes the end dates for the recurring events. The routine then continues at block 918. At block 918, the routine removes the event from the task list. At block 920, the routine splits tasks from the task list (e.g., a system task list) and stores the tasks in a storage. At block 922, the routine splits tasks not having a deadline (e.g., end date) from the task list. At block 924, the routine adds to the smarttime calendar instances of repeating events as follows: (1) for the next two years; (2) end of the repeating event period if the ending is specified earlier than two years later; or (3) next three months when recomputing a timeslot for a task. At block 926, the routine finds new timeslots for tasks having deadlines. When finding timeslots, the smarttime system may identify periods of time during which no event has been scheduled for at least some specified duration. At block 930, the routine finds timeslots for tasks not having a deadline. At block 932, the routine displays the task list and returns at block 934.

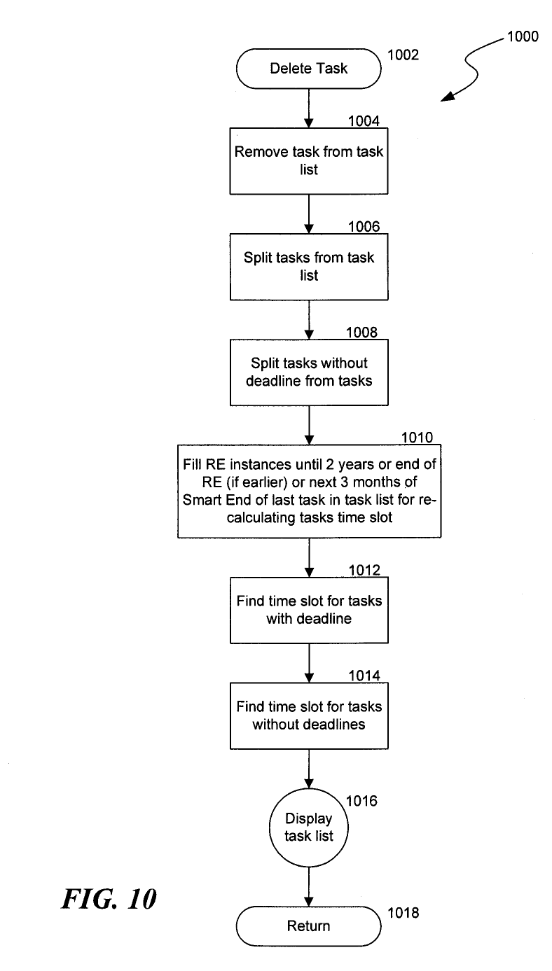

FIG. 10 is a flow diagram illustrating logic invoked by the smarttime system in some embodiments when a user deletes a task in a smarttime calendar. The smarttime system may invoke the routine 1000 when a task is deleted. The routine begins at block 1002. At block 1004, the routine removes the task to be deleted from a task list (e.g., a system task list). At block 1006, the routine splits tasks from the task list (e.g., the system task list) and stores the tasks in a storage. At block 1008, the routine splits tasks not having a deadline (e.g., end date) from the task list. At block 1010, the routine adds to the smarttime calendar instances of repeating events as follows: (1) for the next two years; (2) end of the repeating event period if the ending is specified earlier than two years later; or (3) next three months when recomputing a timeslot for a task. At block 1012, the routine finds new timeslots for tasks having deadlines. When finding timeslots, the smarttime system may identify periods of time during which no event has been scheduled for at least some specified duration. At block 1014, the routine finds timeslots for tasks not having a deadline. At block 1016, the routine displays the task list and returns at block 1018.

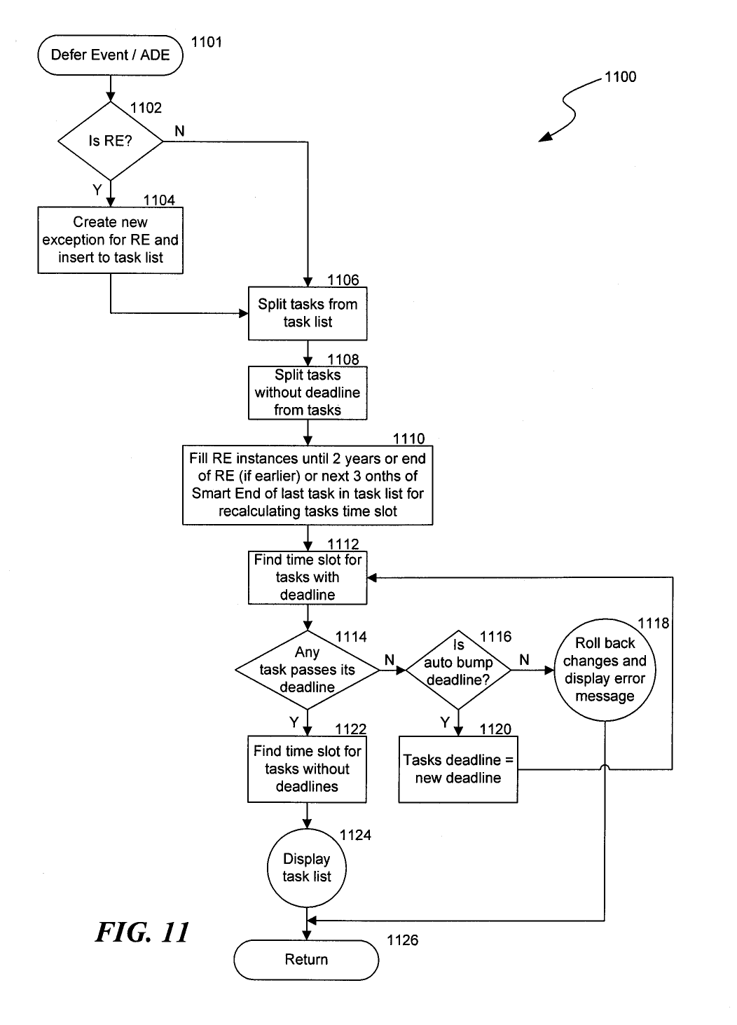

FIG. 11 is a flow diagram illustrating logic invoked by the smarttime system in some embodiments when a user defers an event in a smarttime calendar. The smarttime system may invoke the routine 1100 when an event (e.g., an ADE or RE) is deferred (e.g., upon request by a user). The routine begins at block 1101. At decision block 1102, the routine determines whether the event is a repeating event. If it is a repeating event, the routine continues at block 1104. Otherwise, the routine continues at block 1106. At block 1104, the routine creates a new exception for the repeating event and inserts it into the task list. The routine then continues at block 1106. At block 1106, the routine splits tasks from the task list (e.g., the system task list) and stores the tasks in a storage. At block 1108, the routine splits tasks not having a deadline (e.g., end date) from the task list. At block 1110, the routine adds to the smarttime calendar instances of repeating events as follows: (1) for the next two years; (2) end of the repeating event period if the ending is specified earlier than two years later; or (3) next three months when recomputing a timeslot for a task. At block 1112, the routine finds new timeslots for tasks having deadlines. When finding timeslots, the smarttime system may identify periods of time during which no event has been scheduled for at least some specified duration. At decision block 1114, the routine determines whether any task passes its deadline. A task passes its deadline when it is scheduled for a time after its indicated end date. If any task passes its deadline, the routine continues at block 1122. Otherwise, the routine continues at decision block 1116. At block 1122, the routine finds a timeslot for tasks without deadlines. Once a timeslot is found, the routine may indicate the timeslot for the task in the smarttime calendar and display the task list 1124. The routine then returns at block 1126. At decision block 1116, the routine determines whether a setting has been set to automatically bump deadlines. The setting was described above. If the setting has been set, the routine continues at block 1120. Otherwise, the routine continues at block 1118. At block 1120, the routine sets the task's deadline to a new deadline. The routine then continues at block 1112. At block 1118, the routine rolls back changes to return tasks to their previously scheduled dates and may display an error message. The routine returns at block 1126.

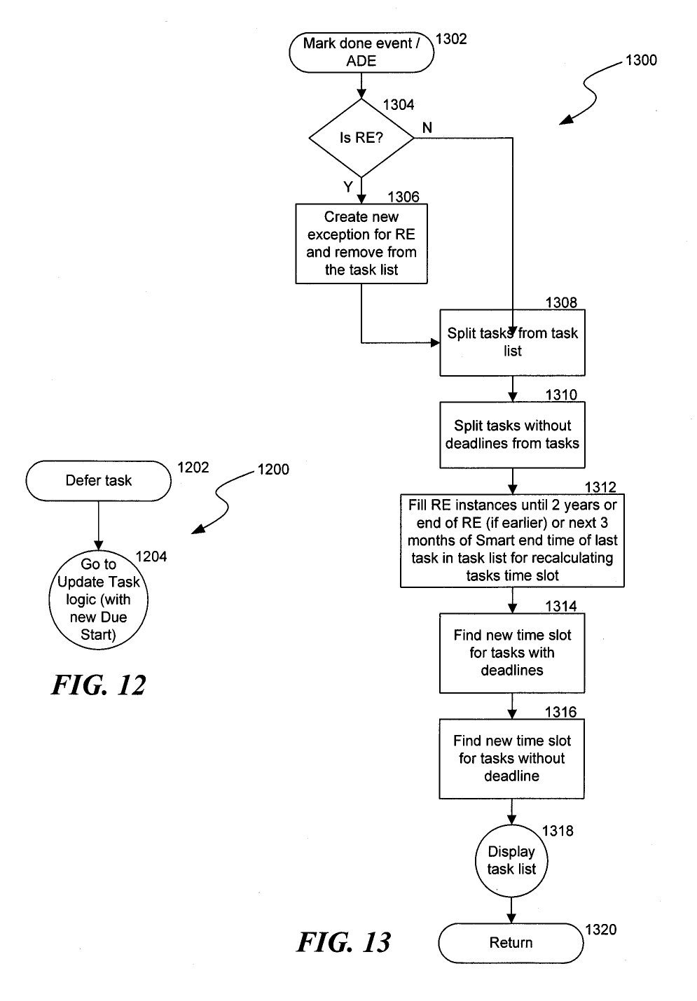

FIG. 12 is a flow diagram illustrating logic invoked by the smarttime system in some embodiments when a user defers a task in a smarttime calendar. The smarttime system may invoke the routine 1200 when a user defers a task. The routine begins at block 1202. At block 1204, the routine invokes the Update Task routine described above in relation to FIG. 8. When invoking the Update Task routine, the Defer Task routine may provide an indication of a new start date (e.g., as specified by the user when deferring the task) or some other parameter that can enable the smarttime system to update the smarttime calendar.

FIG. 13 is a flow diagram illustrating logic invoked by the smarttime system in some embodiments when a user marks an event as completed in a smarttime calendar. The smarttime system may invoke the routine 1300 when a user indicates that an event or ADE is completed. The smarttime system may also invoke the routine when the user indicates that a task has been completed. The routine begins at block 1302. At decision block 1304, the routine determines whether the event is a repeating event (RE). If it is a repeating event, the routine continues at block 1306. Otherwise, the routine continues at block 1308. At block 1306, the routine creates a new exception for the repeating event and inserts it into the task list. The routine then continues at block 1106. At block 1308, the routine splits tasks from the task list (e.g., the system task list) and stores the tasks in a storage. At block 1310, the routine splits tasks not having a deadline (e.g., end date) from the task list. At block 1312, the routine adds to the smarttime calendar instances of repeating events as follows: (1) for the next two years; (2) end of the repeating event period if the ending is specified earlier than two years later; or (3) next three months when recomputing a timeslot for a task. At block 1314, the routine finds new timeslots for tasks having deadlines. At block 1316, the routine finds new timeslots for tasks having deadlines. When finding timeslots, the smarttime system may identify periods of time during which no event has been scheduled for at least some specified duration. At block 1318, the routine displays the task list and then returns at block 1320.

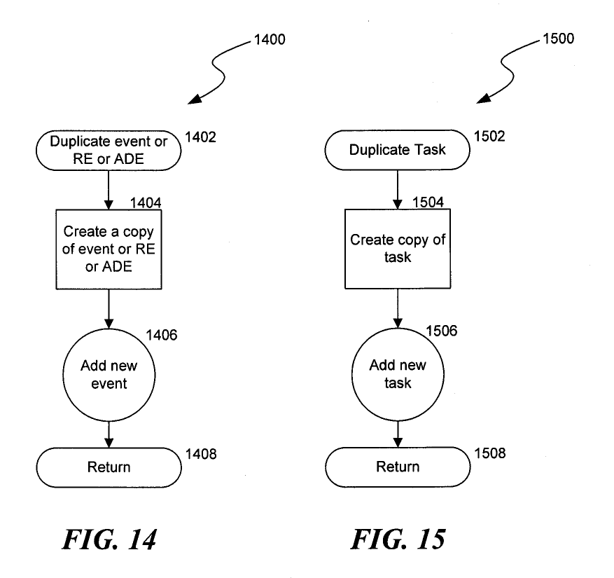

FIG. 14 is a flow diagram illustrating logic invoked by the smarttime system in some embodiments when a user duplicates an event in a smarttime calendar. The smarttime system may invoke the routine when a user indicates to duplicate an event, repeating event (RE), or all-day event (ADE). The smarttime system may invoke the routine 1400, e.g., upon selection by a user. The routine starts at block 1402. At block 1404, the routine creates a copy of the event, RE, or ADE. At block 1406, the routine invokes the Add New Event subroutine (described above in relation to FIG. 5) to add the copied event, RE, or ADE. The routine returns at block 1408.

FIG. 15 is a flow diagram illustrating logic invoked by the smarttime system in some embodiments when a user duplicates a task in a smarttime calendar. The smarttime system may invoke the routine when the user indicates to duplicate a task. The smarttime system may invoke the routine 1500, e.g., upon selection by a user. The routine starts at block 1502. At block 1504, the routine creates a copy of the task. At block 1506, the routine invokes the Add New Task subroutine (described above in relation to FIG. 6) to add the copied task. The routine returns at block 1508.

FIG. 16 is a flow diagram illustrating logic invoked by the smarttime system in some embodiments to automatically schedule tasks and/or events. The smarttime system may invoke the routine 1600, e.g., upon selection by a user or invocation by another routine of the smarttime system (e.g., routine 400 described above in relation to FIG. 4). The routine starts at block 1602. At decision block 1604, the routine determines whether a setting has been set to automatically bump deadlines. The setting was described above. If the setting has been set, the routine continues at block 1608. Otherwise, the routine continues at block 1614. At decision block 1608, the routine determines whether any task is past its deadline. If not, the routine continues at block 1614. Otherwise, the routine continues at block 1612. At block 1612, the routine calculates new timeslots for tasks (e.g., for tasks that are past their deadline). The routine then continues at block 1614 where it displays tasks and events (e.g., items in the smarttime calendar). The routine then returns at block 1616.

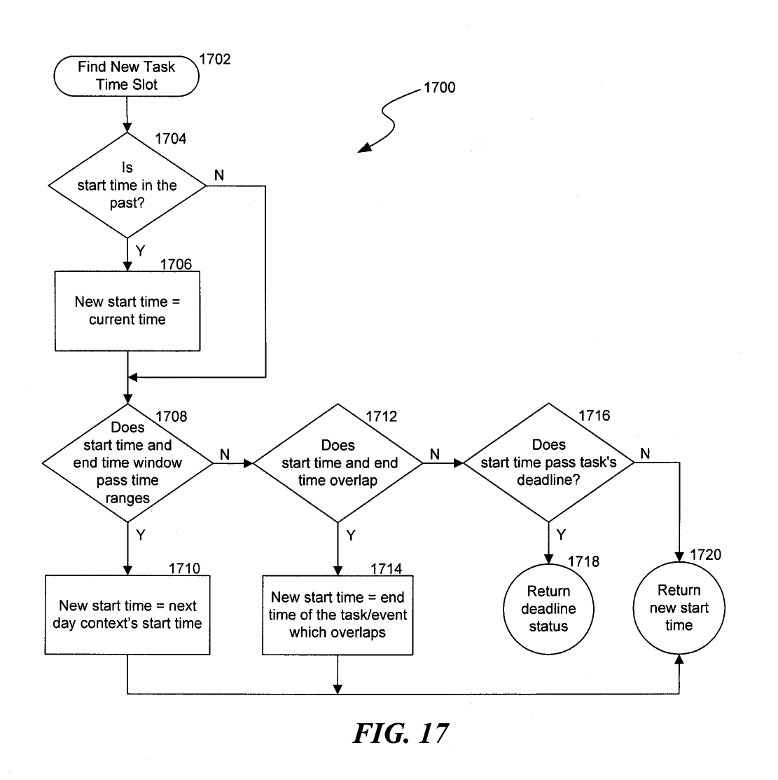

FIG. 17 is a flow diagram illustrating logic invoked by the smarttime system in some embodiments to identify a timeslot for a task. The smarttime system may invoke the routine 1700, e.g., upon selection by a user or invocation by another routine of the smarttime system. The routine starts at block 1702. At decision block 1704, the routine determines whether the indicated start time for the task occurs in the past. If it does, the routine continues at block 1706. Otherwise, the routine continues at decision block 1708. At block 1706, the routine sets the start time of the task to the current time (e.g., as indicated by the computing device on which the smarttime system operates). At decision block 1708, the routine determines whether the start time and the end time window pass time ranges. As an example, the window may pass a time range if the task has an indicated start time or end time and either of these indicated times do not fall within the time period in the smarttime calendar that has been selected for the task. If that is the case, the routine continues at block 1710. Otherwise, the routine continues at decision block 1712. At block 1710, the routine sets the new start time for the task to the next day context's start time. As an example, if the task is a “home” task, the routine may set the start time to the start of the time period that is free and within the period of time indicated to be “home time.” Alternatively, if the task is a “work” task, the routine may set the start time to the start of the time period that is free and within the period of time indicated to be “work time.” In various embodiments, home time and work time can be set by the user. Some tasks that are home tasks may nevertheless need to be completed during work time or vice versa. The user may, for example, indicate that a task must be completed during one of these time periods. After completing the logic of block 1710, the routine continues at block 1720. At decision block 1712, the routine determines whether the start time and end time for the task overlap. If they do, the routine at block 1714 sets the new start time of the task to the end time of the task or event that overlaps and then continues at block 1720. Otherwise, the routine continues at decision block 1716, at which the routine determines whether the start time passes the task's deadline (e.g., specified end date). If it does, the routine continues at block 1718 where it returns the deadline status for the task. Otherwise, the routine continues at block 1720. At block 1720, the routine returns the new start time for the task.

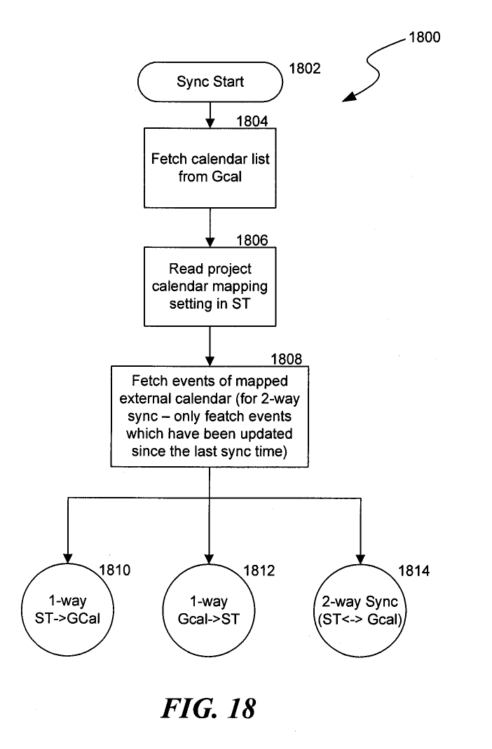

FIGS. 18-21 are flow diagrams illustrating logic invoked by the smarttime system in various embodiments to synchronize a smarttime calendar.

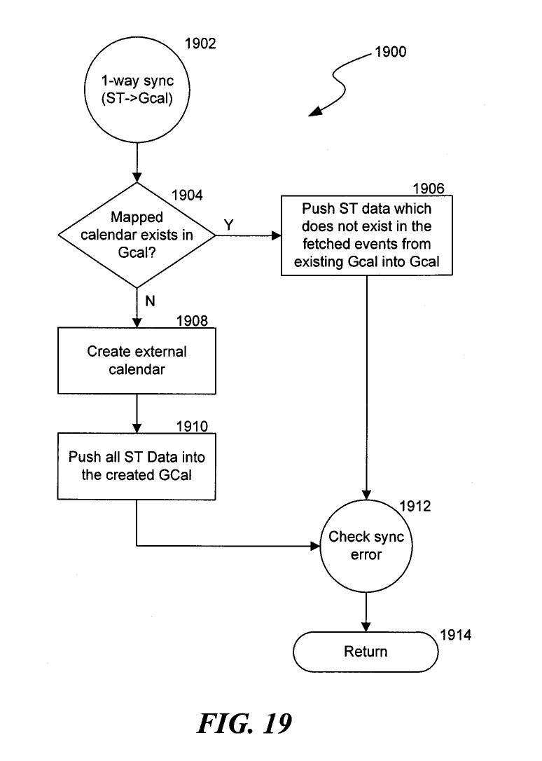

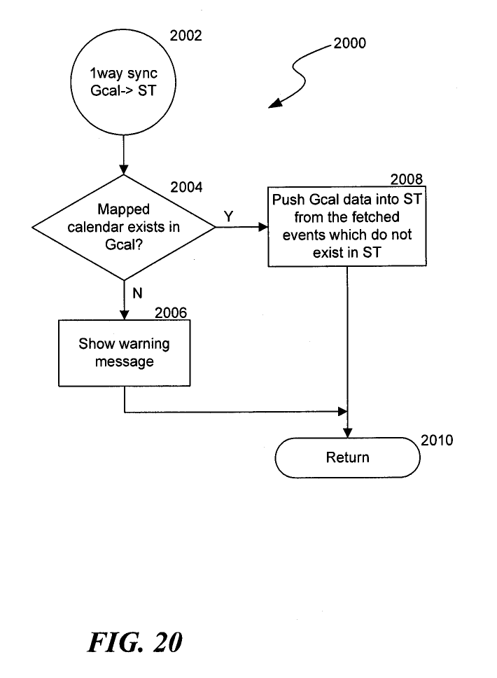

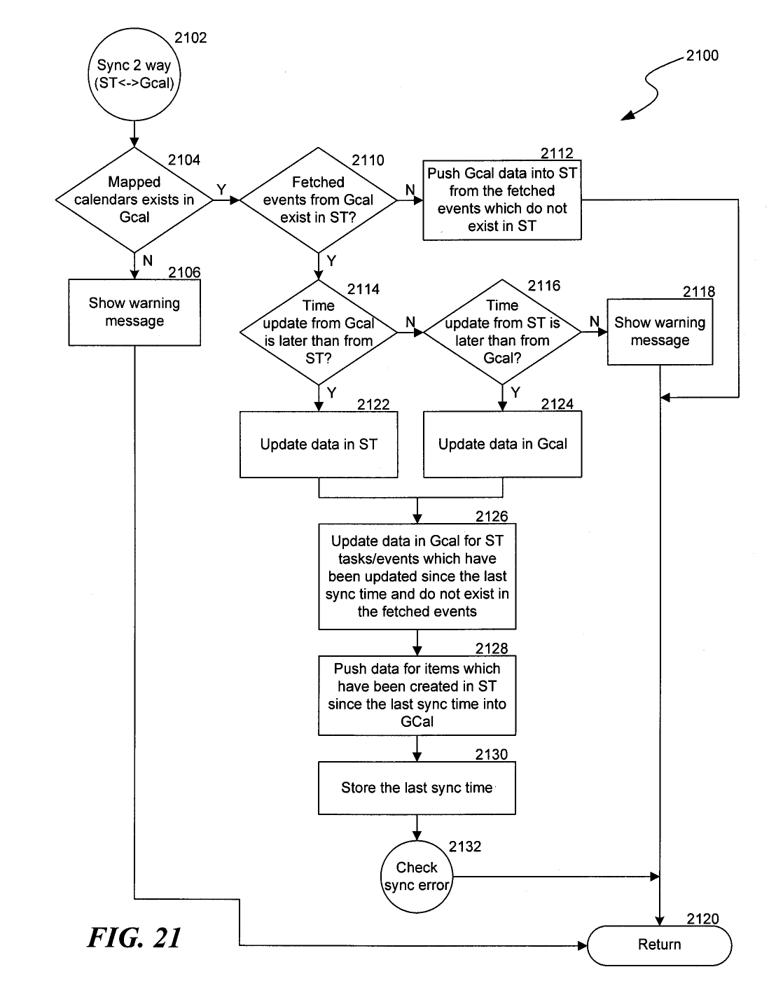

Routine 1800 begins at block 1802. At block 1804, the routine fetches a calendar list from an external calendar, such as a GOOGLE calendar. At block 1806, the routine reads a project calendar mapping setting of the smarttime system. At block 1808, the routine fetches events from the external calendar. In some embodiments, the smarttime system performs a two-way synchronization between the smarttime calendar and the external calendar. In these embodiments, the routine may fetch events from the external calendar that have been updated since the last synchronization. If the routine is being invoked to perform a one-way calendar synchronization from the smarttime calendar to the external calendar, the routine continues at block 1810. If the routine is being invoked to perform a one-way calendar synchronization from the external calendar to the smarttime calendar, the routine continues at block 1812. If the routine is being invoked to perform a two-way calendar synchronization between the external calendar and the smarttime calendar, the routine continues at block 1814. The logic associated with block 1810 is described below in relation to FIG. 19. The logic associated with block 1812 is described below in relation to FIG. 20. The logic associated with block 1814 is described below in relation to FIG. 21.

Subroutine 1900 in FIG. 19 continues from block 1810 of FIG. 18 at block 1902. At decision block 1904, the routine determines whether an indicated calendar exists at the external database. If it does, the routine continues at block 1906. Otherwise, the routine continues at block 1908. At block 1906, the routine “pushes” to the external calendar the smarttime calendar data that does not exist in the events that were fetched from the existing external calendar. Pushing data to an external calendar involves invoking an application program interface provided by the external calendar, e.g. to store or update calendar information. The routine then continues at block 1912 wherein it checks for synchronization errors. At block 1908, the routine creates an external calendar, such as by invoking an application program interface provided by the external calendar database or system. At block 1910, the routine pushes all smarttime calendar information to the created external calendar. The routine then returns at block 1914.

Subroutine 2000 in FIG. 20 continues from block 1812 of FIG. 18 at block 2002. At decision block 2004, the routine determines whether an indicated calendar exists at the external database. If it does, the routine continues at block 2006. Otherwise, the routine continues at block 2008. At block 2008, the routine “pushes” to the external calendar the smarttime calendar data that does not exist in the events that were fetched from the existing external calendar. The routine then continues at block 2010. At block 2006, the routine displays a warning message (e.g., indicating that the external calendar could not be located). The routine then continues at block 2010. At block 2010, the routine returns.

Subroutine 2100 in FIG. 21 continues from block 1814 of FIG. 18 at block 2102. At decision block 2104, the routine determines whether an indicated calendar exists at the external database. If it does, the routine continues at decision block 2110. Otherwise, the routine continues at block 2106. At block 206, the routine displays a warning message (e.g., indicating that the identified calendar could not be found) and then continues at block 2120. At decision block 2110, the routine determines whether events from the external calendar exist in the smarttime calendar. If they do, the routine continues at decision block 2114. Otherwise, the routine continues at block 2112. At block 2112, the routine pushes (e.g., retrieves) external calendar data into the smarttime calendar from the previously fetched events that do not exist in the smarttime calendar. The routine then continues at block 2120. At decision block 2114, the routine determines whether the updates received from the external calendar are later than the last updates made to the external calendar from the smarttime calendar. If they are, the routine continues at block 2122. Otherwise, the routine continues at decision block 2116. At decision block 2116, the routine determines whether the updates made to the external calendar from the smarttime calendar are later than the updates received from the external calendar. If they are, the routine continues at block 2124. Otherwise, the routine continues at block 2118. At block 2118, the routine displays a warning message (e.g., indicating a synchronization error in determining which calendar is most up-to-date) and then continues at block 2120. At block 2122, the routine updates data stored in the smarttime calendar with data from the external calendar. The routine then continues at block 2126. At block 2124, the routine updates the data stored in the external calendar with data from the smarttime calendar. The routine then continues at block 2126. When updating the data between the calendars, the smarttime system may employ a unique identifier that is assigned to the events and tasks. In some embodiments, the smarttime system may provide an assign the unique identifiers. At block 2126 the routine updates the data in the external calendar for smarttime tasks and events that have been updated since the last synchronization and do not exist in the fetched events. At block 2128, the routine pushes data to the external database that have been created in the smarttime calendar since the last synchronization to the external database. At block 2130, the routine stores the last synchronization time. At block 2132, the routine checks to see if there have been any synchronization errors and may report the errors to the user. At block 2120, the routine returns.

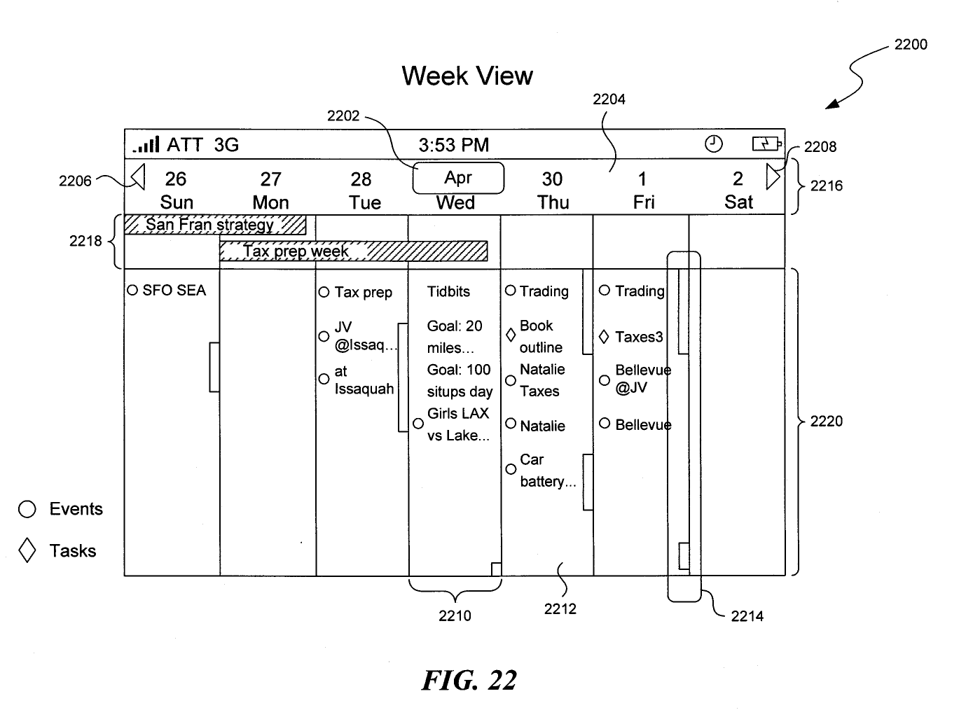

FIGS. 22-32F are user interface diagrams illustrating aspects of a user interface provided by the smarttime system in various embodiments. A user can make the selections described below via user of a stylus, finger, mouse pointer, etc.

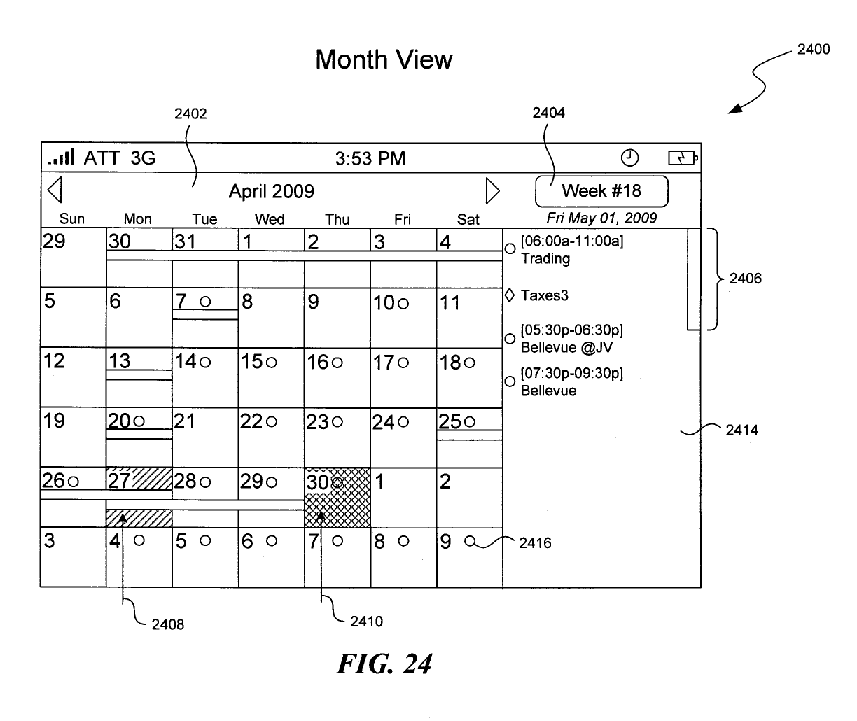

FIG. 22 illustrates a weekly view 2200 of the user interface provided by the smarttime system in some embodiments. A user can select the displayed month name 2202 to select a monthly view (described below in relation to FIG. 24). A user can select any region of a date bar 2216, e.g. region 2204, to open a window that the user can employ to add a new task or event. The user can select a back button 2206 or a forward button 2208 to move backward or forward in the calendar, respectively. A region 2216 can display projects or time horizons during which related tasks or events are scheduled. Each project were time Verizon may have an associated color. Bullets appearing with task or event names in region 2220 may also indicate the same colors to show related tasks or events. As an example, the “Tax prep” item on Tuesday, April 28, and the “Taxes3” item on Friday, May 1, may have the same-colored bullets. The bullets may distinguish between events (e.g., circular bullets) and tasks (e.g., diamond-shaped bullets). The current day may be shaded (e.g., region 2210; shading not illustrated). By selecting a particular day (e.g., region 2212), the user can display additional details about the selected day. Bars in regions of each day (e.g., bars 2214) may be shaded to indicate portions of days that have scheduled events. The bars may be color-coded to show associations with particular projects.

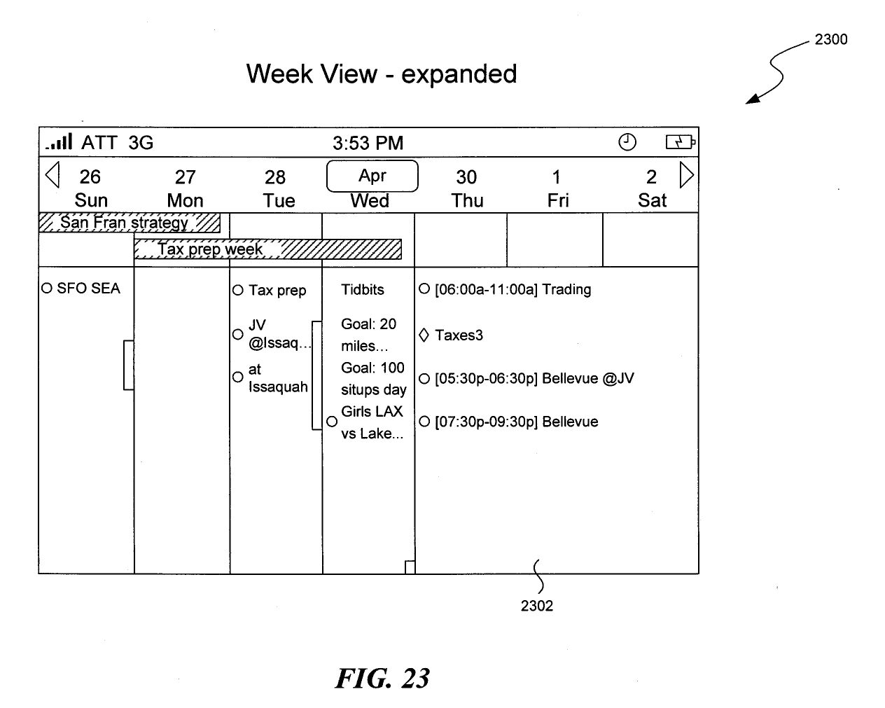

FIG. 23 illustrates an extended weekly view 2300 of the user interface. By selecting a region 2302, the user can expand the font and width of each entry for a particular day. For example, FIG. 23 illustrates that the user has expanded the data for April 30 by selecting region 2212 of FIG. 22.

FIG. 24 illustrates a monthly view 2400 of the user interface provided by the smarttime system in some embodiments. A user can select a date bar region 2402 to open a window that the user can employ to add a new task or event. A user can select a week region 2404 to display the weekly view described above in relation to FIG. 22. Region 2414 shows details (e.g., scheduled tasks and/or events) for a selected day. In the illustration, May 1, 2009, has been selected. Days may have different shadings. For example, day 2408 has a lighter shading than day 2410, but day 2408 has a darker shading than many other days. The darker a day is shaded, the busier that day is indicated to be. For example, a day with several scheduled events may be much darker than a day with no scheduled events. Icons or glyphs (e.g., icon 2416) associated with a day can indicate that at least one scheduled event or task is associated with that day.

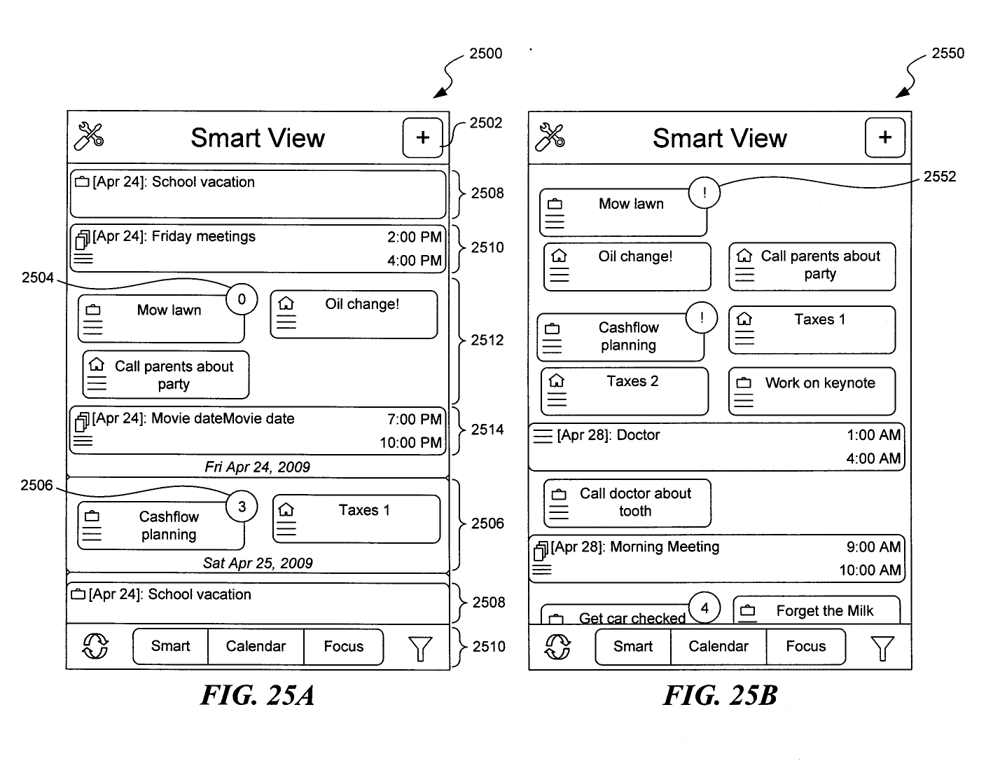

FIG. 25B illustrates a smart view 2500. A user can add a task or event by selecting icon 2502. According to the illustration, there is a work task 2508 (identified by a briefcase) and an event 2510 having a start time at 2 PM and an end time at 4 PM. Multiple tasks are assigned during the period 2512 before another event beginning at 7 PM (2514). These events and tasks are scheduled for Friday, Apr. 24, 2009. Region 2506 illustrates tasks scheduled from Saturday, Apr. 25, 2009. A task to mow the lawn is due on zero days (indicated by indicator 2504) and a task to complete cash flow planning is due in three days (indicated by indicator 2506). Region 2508 shows future tasks and events (after April 25) and region 2510 provides other user interface options.

FIG. 25B illustrates what the user interface 2550 could look like three days later. The mow lawn task and the cash flow planning tasks are now illustrated as overdue, e.g., by indicator 2552, because the user did not mark them as completed and three days has transpired. Moreover, they now appear at the top of the list (e.g., before other scheduled events or tasks) because they are overdue.

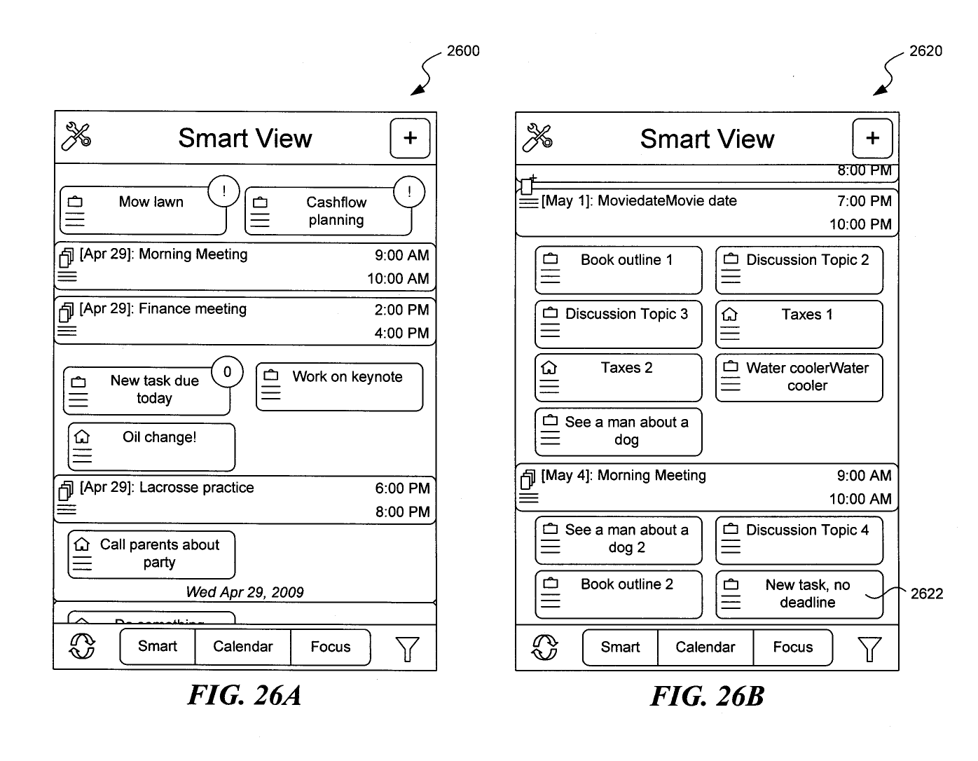

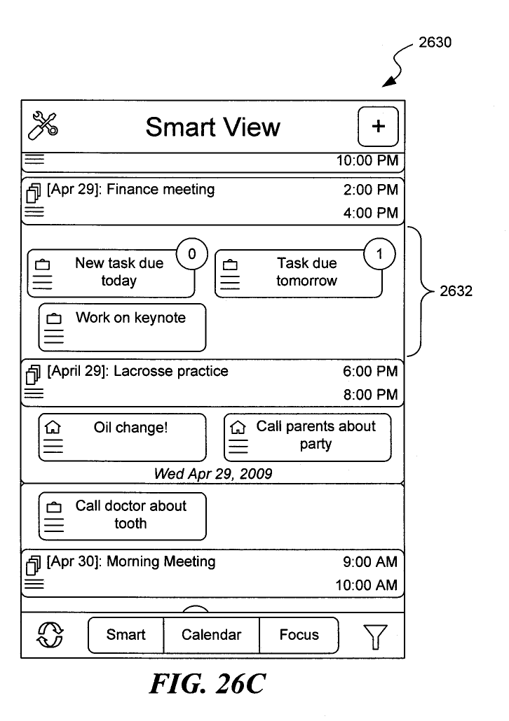

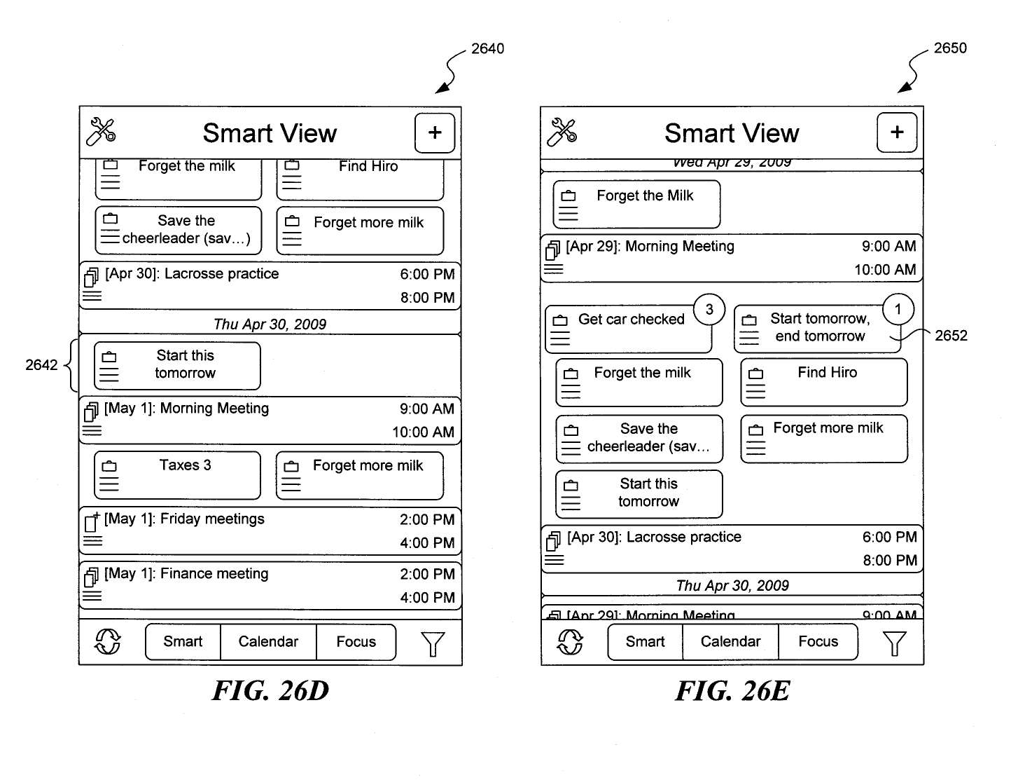

FIG. 26A illustrates a user interface 2600 showing what happens when the task list is updated and time slots for existing tasks have been passed. For example, the mow lawn and cash flow planning tasks are overdue and continue to appear before the scheduled events/tasks whereas other tasks appear after scheduled events/tasks.

FIG. 26B illustrates a user interface 2620 in which a new task 2622 without a deadline has been added. FIG. 26C illustrates a user interface 2630 in which new tasks due today and tomorrow are added (illustrated in region 2632). Because they have specified deadlines, they take precedence over other tasks that do not have deadlines.

FIG. 26D illustrates a user interface 2640 in which a new task 2642 is added with a “start horizon” (e.g., a time after which it must be started) of Thursday, Apr. 30, 2009. The smarttime system scheduled the task for April 30. In FIG. 26E, a user interface 2650 illustrates that a task 2652 having a specified deadline is scheduled earlier than other tasks that do not have a specified deadline (e.g., Find Hiro).

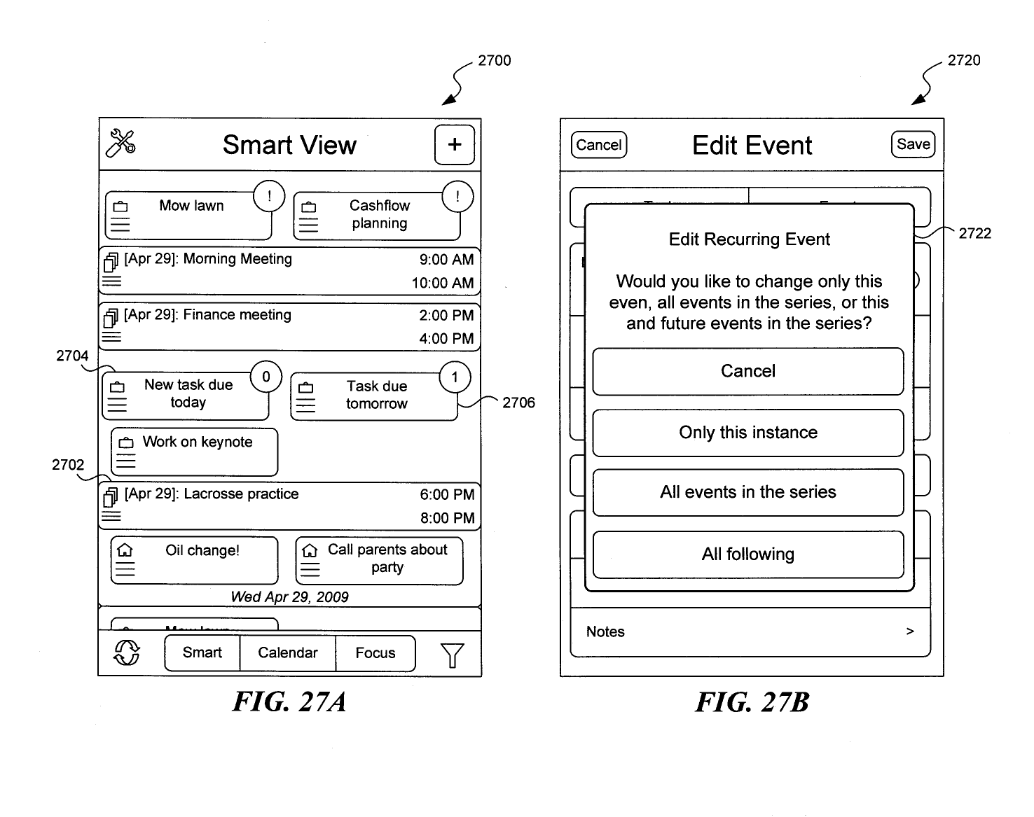

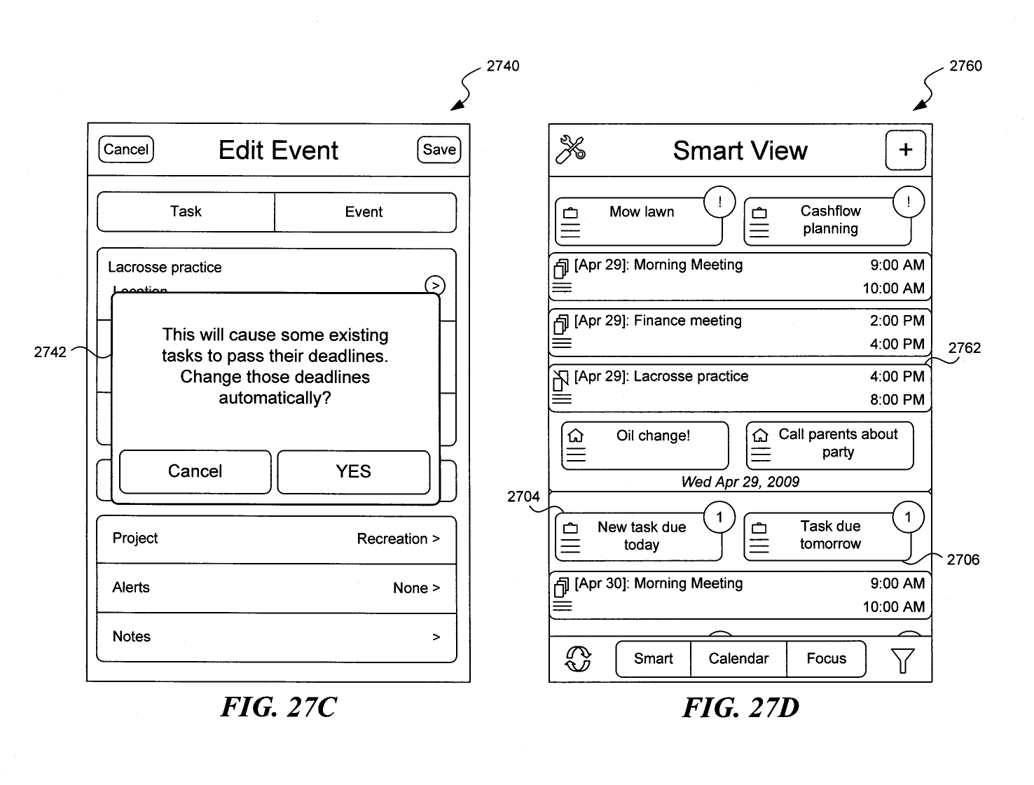

FIGS. 27A-D illustrate a user interface for updating an event. In FIG. 27A, user interface 2700 has tasks 2704 and 2706 having deadlines (today and tomorrow, respectively). When a recurring event 2702 (indicated by multiple document glyphs) is edited to increase its duration and change its start time, a window 2722 appears (FIG. 27B, user interface 2720) asking the user how the update should be handled. If the user selects the “Only this instance” option, a second window 2742 appears (FIG. 27C, user interface 2740) confirming that the change will require some tasks to pass their deadlines (e.g., because the tasks cannot be scheduled in the remaining open time periods). If the user elects to change those deadlines automatically, user interface 2760 of FIG. 27D appears in which the event has been updated (2762) and the tasks 2704 and 2706 have been moved to the following day.

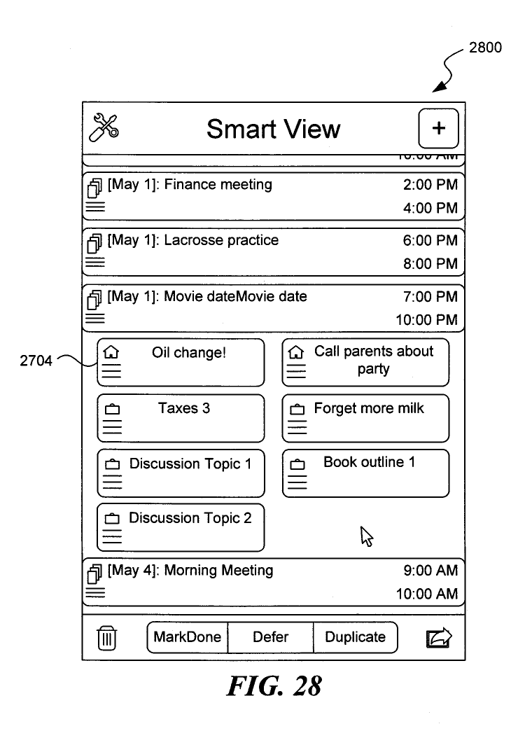

FIG. 28 illustrates a user interface for updating a task. The user interface 2800 indicates that the “Oil change!” task 2704 has been moved to several days later (e.g., because its updated duration no longer fits in earlier days).

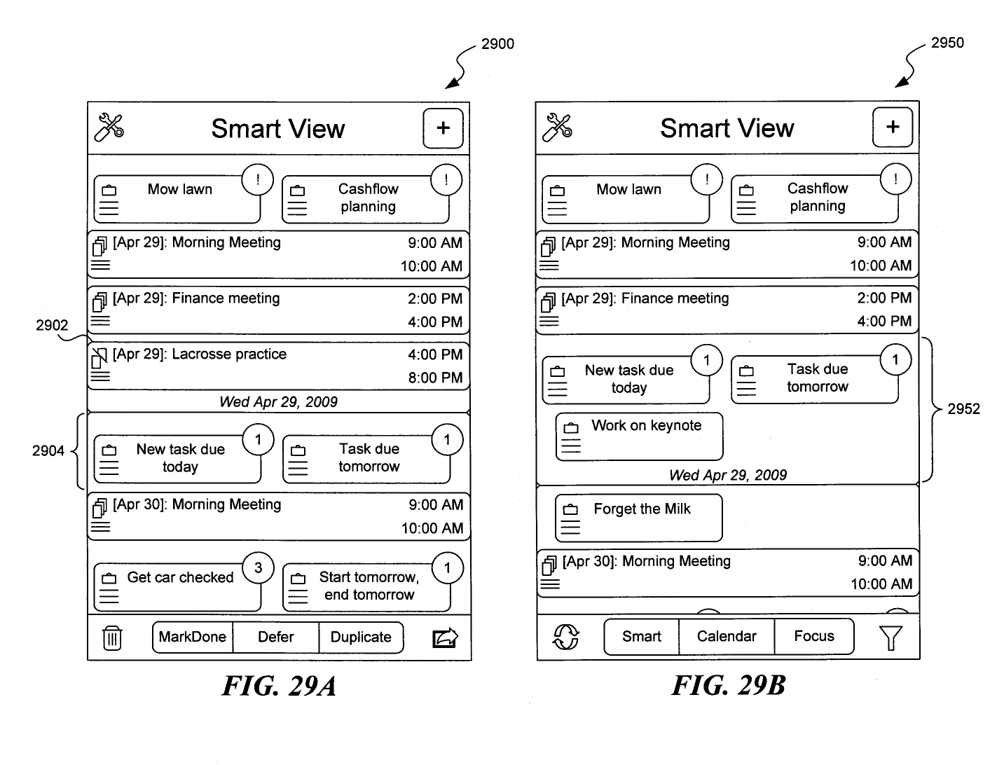

FIGS. 29A-B illustrate user interfaces 2900 and 2950 illustrating that when an event 2902 is deleted, tasks in region 2904 can be rescheduled to be completed earlier (region 2952)—e.g., April 29 instead of April 30—because there is a schedule opening made by the cancellation.

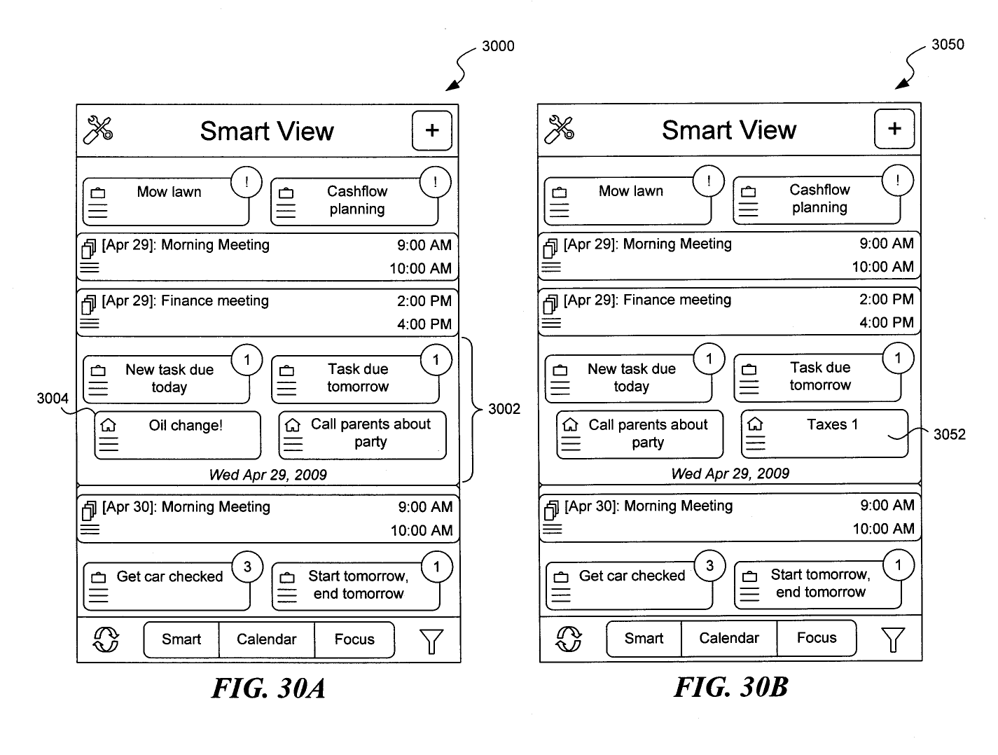

FIGS. 30A-B illustrate user interface embodiments 3000 and 3050 illustrating deleting a task. Deleting task 3004 in region 3002 causes a new task 3052 to appear that was previously scheduled for later.

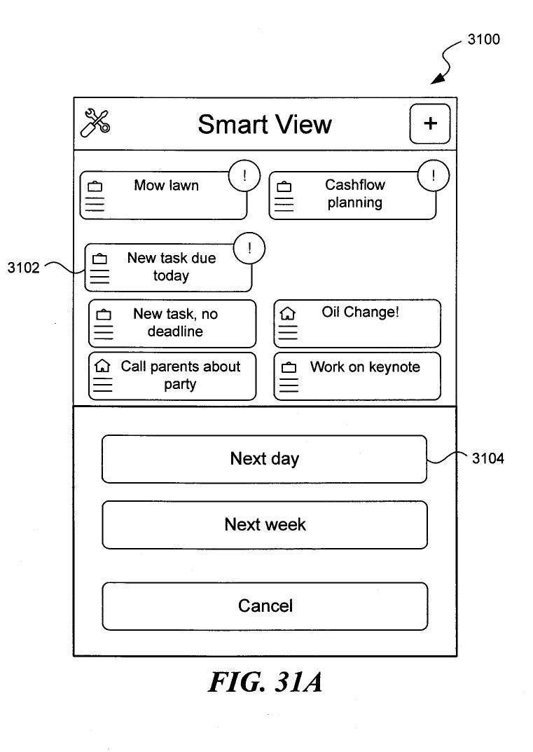

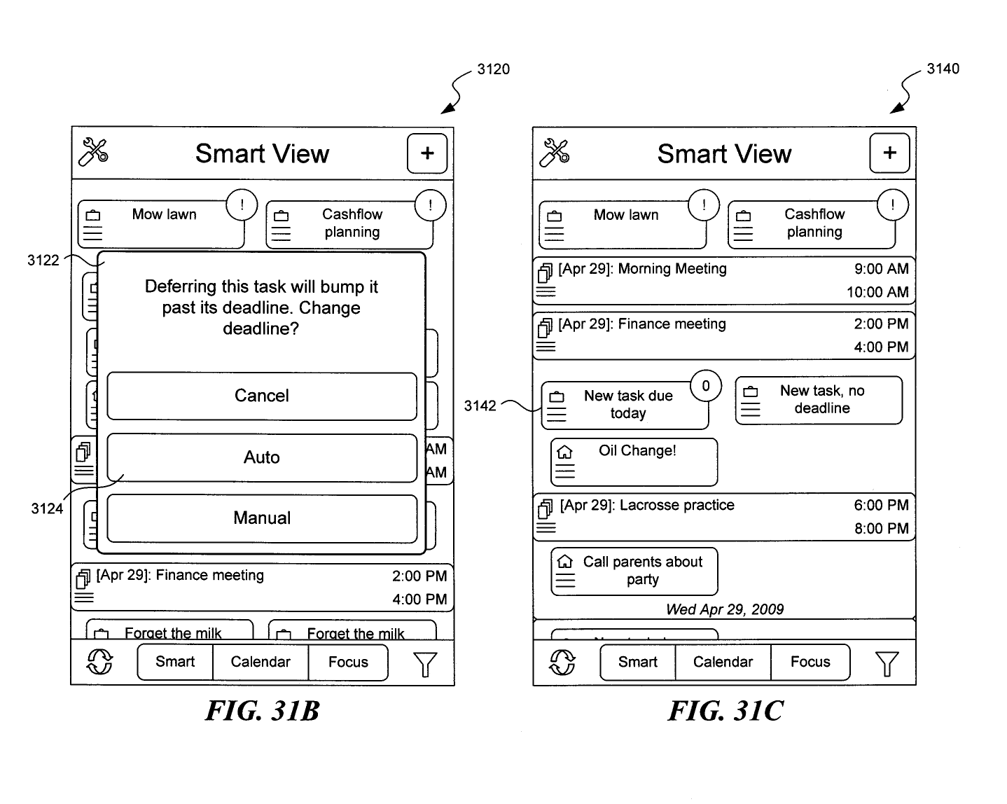

FIGS. 31A-C illustrate other aspects of the user interface. In FIG. 31A, a user has selected a task 3102 in user interface 3100 and by selecting an Action symbol or icon (e.g., the “plus” icon at the top-right of the user interface), the user can defer the task by selecting a next day pushbutton 3104. Doing so causes a window 3122 of user interface 3120 to appear. The window includes an Auto button 3124 that the user can select to automatically bump deadlines for tasks. Once done, the new task that was previously indicated as overdue has been moved to April 29 and is no longer overdue, as is illustrated in FIG. 31C, user interface 3140, task 3142.

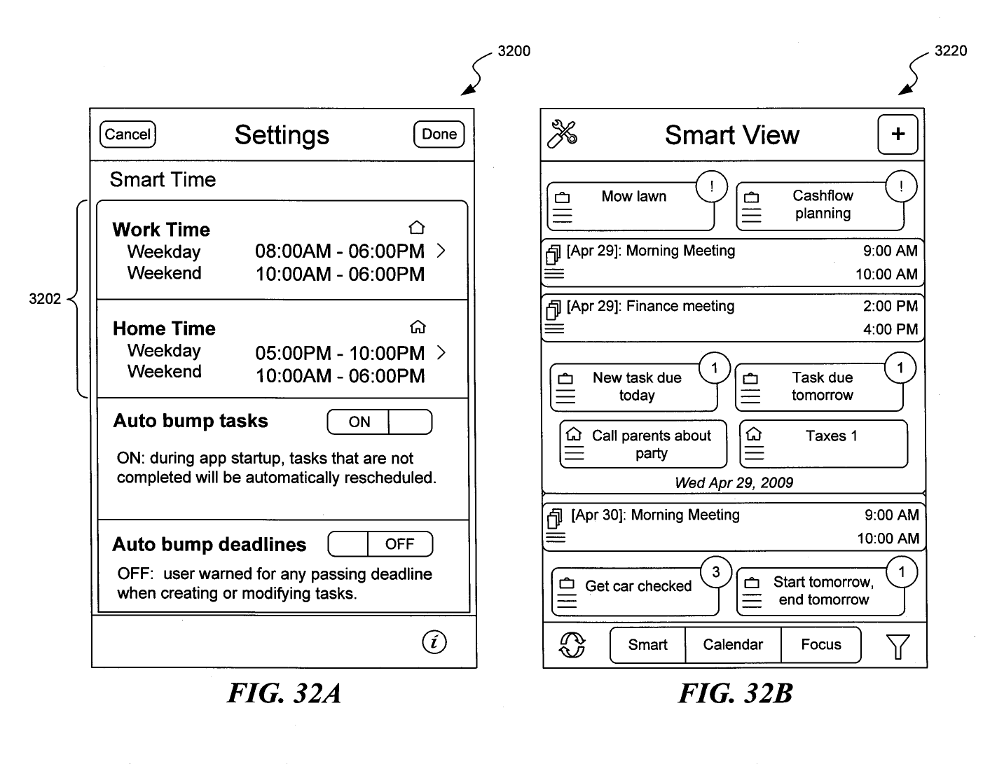

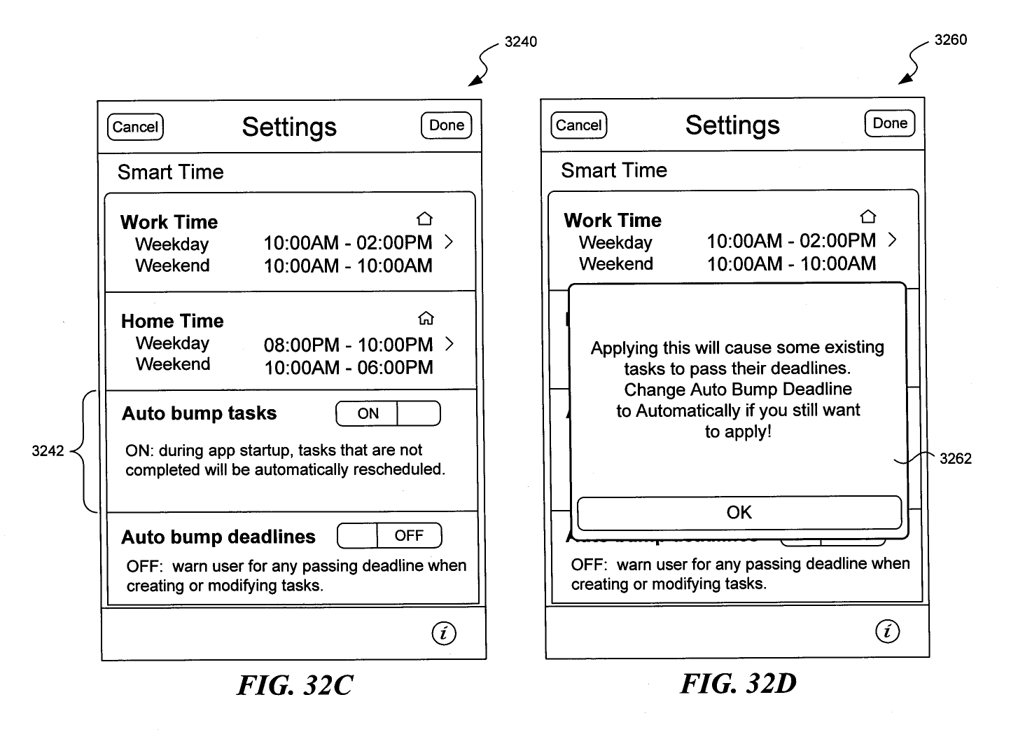

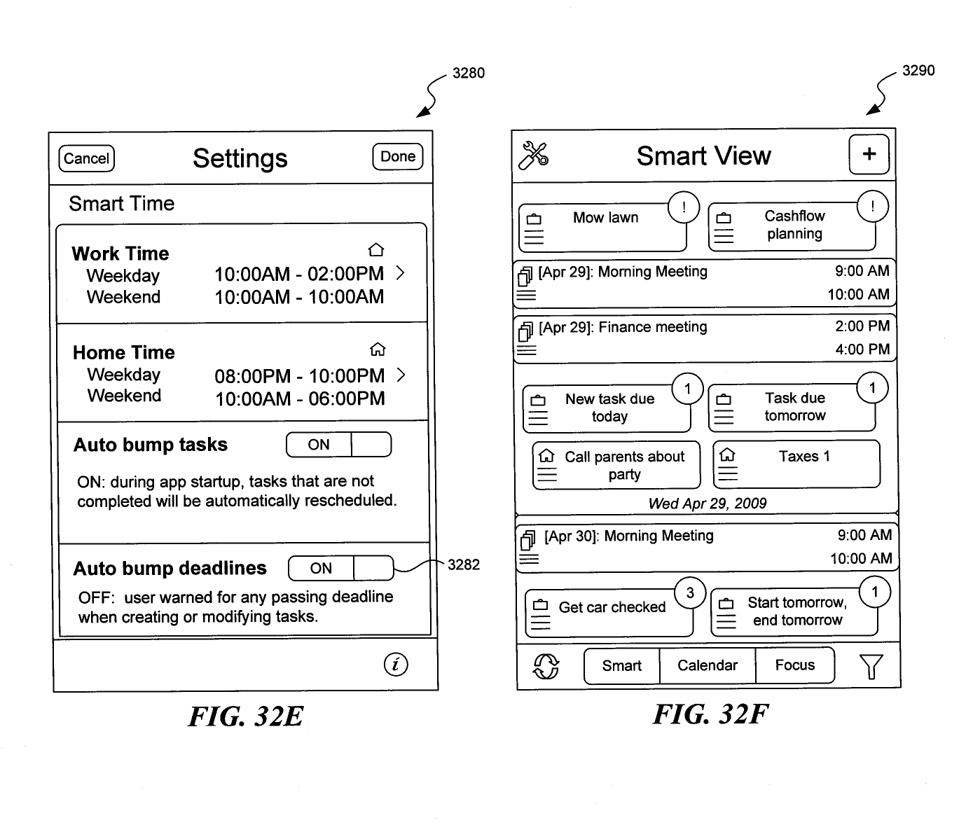

FIGS. 32A-F illustrate context settings. In FIG. 32A, user interface 3200 includes work time and home time settings. By changing the time periods associated with each setting, the user can control into which time periods tasks are automatically scheduled by the smarttime system. In FIG. 32B, tasks with a home icon (indicating personal or home tasks) are scheduled during home time periods and tasks with a briefcase icon (indicating work tasks) are scheduled during work time periods.

In FIG. 32C, an “auto bump tasks” setting is turned on in region 3242 of user interface 3240. In user interface 3260 of FIG. 32D, window 3262 appears indicating that the setting will cause some tasks to pass their deadlines.

In FIG. 32E, when an auto bump deadlines setting 3282 is enabled, tasks having deadlines may be automatically postponed by the smarttime system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing system having a processor and memory for managing events and tasks, comprising:
retrieving by the computing system a first task from a task database;
retrieving an event from an event database;
computing a priority the first task based on whether a start date or an end date is specified for the first task;
automatically scheduling the first task and the event into a calendar so that the first task is scheduled for completion during a first time for which no event is specified;
when the event, another event, or a second task conflicts with the scheduled time for the first task, automatically changing the scheduled time for the first task based on the computed priority to a second time;
updating the calendar so that the first task is scheduled for completion during the second time; and
displaying the calendar.

2. A system for managing events and tasks, comprising:
a processor and a memory;
a component configured to retrieve task information from a task database, the task information comprising at least a first task;
a component configured to retrieve calendar information from a calendar database, the calendar information comprising at least an event; and
a component configured to (a) automatically schedule the first task and the event into a calendar so that the first task is scheduled for completion during a first time for which no event is specified; (b) when the event, another event, or a second task conflicts with the scheduled time for the first task, automatically changes the scheduled time for the first task based on the computed priority to a second time; and (c) updates the calendar so that the first task is scheduled for completion during the second time.

3. A computer-readable storage medium storing a data structure, comprising:
information about a first task that is employed to compute a priority for the first task; and
information specifying a first time duration during which the first task is scheduled for completion wherein the first time duration is computed based on the computed priority.

4. The computer-readable storage medium of claim 3 further comprising information specifying a second task or event that is scheduled during the time specified first time duration and information specifying a second time duration during which the first task is scheduled for completion wherein the second time duration is computed based on the computed priority and is different from the first time duration.
